(19) United States
(12) Patent Application Publication
(10) Pub. No.: US 2006/0218378 A1
(43) Pub. Date: Sep. 28, 2006

(54) Integrated circuit device

(75) Inventor: Makoto Kudo, Fujimi (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/389,458

(22) Filed: Mar. 24, 2006

(30) Foreign Application Priority Data
Mar. 25, 2005 (JP) 2005-089253

(51) Int. Cl. G06F 9/30

(52) U.S. Cl. 712/208

(57) ABSTRACT

An integrated circuit device including: a CPU which executes given processing based on an instruction code; an instruction code bus used to supply an instruction code to the CPU from a memory; and an instruction code supply line used to supply an instruction code output from a coprocessor to the CPU. The CPU includes: a fetch section which fetches an instruction code; and an instruction code select circuit which receives an instruction code input through the instruction code bus and an instruction code supplied through the instruction code supply line, and supplies one of the instruction codes to the fetch section.

Japanese Patent Application No. 2005-89253, filed on Mar. 25, 2005, is hereby incorporated by reference in its entirety.

### BACKGROUND OF THE INVENTION

The present invention relates to an integrated circuit device.

In recent years, various electronic instruments have been increasingly demanded along with an improvement in semiconductor technology. A central processing unit (CPU) for performing various types of control processing is generally provided in such electronic instruments. In order to provide a higher processing performance for an electronic instrument including a processor, it is known that a coprocessor which performs specific processing is provided in addition to the CPU. In this case, the processing of the entire electronic instrument can be performed at high speed by causing the coprocessor to perform processing in which the CPU is weak.

However, when a number of processing results of the coprocessor exist or the amount of data of the processing results is large, the CPU cannot receive the processing results or the like from the coprocessor at one time due to limitations to the bus which connects the CPU and the coprocessor. This makes it necessary for the CPU to receive information from the coprocessor a number of times, so that an increase in the processing performance is hindered. In order to further increase the processing performance, it is necessary to increase the operating clock frequency or to increase the hardware scale. However, this hinders a reduction in power consumption and cost. JP-A-2000-284962 discloses a microcomputer having a function of extending operation contents for executing an operation which cannot be described in a short instruction code.

### SUMMARY

According to a first aspect of the invention, there is provided an integrated circuit device having a CPU which executes given processing based on an instruction code, the integrated circuit device comprising:

an instruction code bus used to supply an instruction code to the CPU from a memory; and

an instruction code supply line used to supply an instruction code output from a coprocessor to the CPU,

the CPU including:

a fetch section which fetches an instruction code; and

an instruction code select circuit which receives an instruction code input through the instruction code bus and an instruction code supplied through the instruction code supply line, and supplies one of the instruction codes to the fetch section.

According to a second aspect of the invention, there is provided an integrated circuit device having a CPU which executes given processing based on an instruction code, the integrated circuit device comprising:

an instruction address bus used to supply an instruction address to a memory; and

an instruction address supply line used to supply an instruction address output from a coprocessor to the CPU,

the CPU including:

a fetch section which fetches an instruction code; and

an instruction address select circuit which receives an instruction address supplied through the instruction address supply line and an instruction address supplied from the fetch section, and supplies one of the instruction addresses to the instruction address bus.

According to a third aspect of the invention, there is provided an integrated circuit device having a CPU which executes given processing based on an instruction code, the integrated circuit device comprising:

first and second register data supply lines used to respectively supply first and second register data output from a coprocessor to the CPU,

the CPU including:

a register file including a plurality of registers; and

a first register data select circuit which receives the first register data supplied through the first register data supply line and CPU internal data, and supplies one of the first register data and the CPU internal data to the register file, and p the second register data output from the coprocessor being supplied to the register file through the second register data supply line.

According to a fourth aspect of the invention, there is provided an integrated circuit device having a CPU which executes given processing based on an instruction code, the integrated circuit device comprising:

a data address supply line used to supply a data address output from a coprocessor to the CPU,

the CPU including:

a load/store section which writes data into a memory by supplying a data address to the memory through a data address bus and supplying write data through a write data bus; and

a data address select circuit which receives a data address supplied through the data address supply line and a data address output from the load/store section, and supplies one of the data addresses to the data address bus.

According to a fifth aspect of the invention, there is provided an integrated circuit device having a CPU which executes given processing based on an instruction code, the integrated circuit device comprising:

a write data supply line used to supply write data output from a coprocessor to the CPU,

the CPU including:

a load/store section which writes data into a memory by supplying a data address to the memory through a data address bus and supplying write data through a write data bus; and

a write data select circuit which receives write data supplied through the write data supply line and write data output from the load/store section, and supplies one of the write data to the write data bus.

According to a sixth aspect of the invention, there is provided an integrated circuit device having a CPU which executes given processing based on an instruction code, the integrated circuit device comprising:

a read data supply line used to supply read data output from a coprocessor to the CPU,

the CPU including:

a load/store section which reads data from a memory by supplying a data address to the memory through a data address bus and receiving read data through a read data bus; and

a read data select circuit which receives read data supplied through the read data supply line and read data supplied from the read data bus, and supplies one of the read data to the load/store section.

### BRIEF DESCRIPTION OF THE SEVERAL VIEWS OF THE DRAWING

FIG. 1 is a block diagram showing an integrated circuit device according to one embodiment of the invention.

FIG. 2 is a block diagram showing a CPU according to one embodiment of the invention.

FIG. 3 shows the connection between the CPU and a coprocessor according to one embodiment of the invention.

FIG. 4 is a block diagram showing the connection between a fetch section and the coprocessor according to one embodiment of the invention.

FIG. 5 is a block diagram showing the connection between a register file and the coprocessor according to one embodiment of the invention.

FIG. 6 is a block diagram showing the connection between an ALU and the coprocessor according to one embodiment of the invention.

FIG. 7 is a block diagram showing the connection between a load/store section and the coprocessor according to one embodiment of the invention.

FIG. 8 is a configuration example of an instruction code according to one embodiment of the invention.

FIG. 9 shows loop processing in the integrated circuit device according to one embodiment of the invention.

FIG. 10 is a timing chart at the start of the loop processing shown in FIG. 10.

FIG. 11 is an example of instruction codes in the loop processing shown in FIG. 10.

FIG. 12 is a timing chart at the end of the loop processing shown in FIG. 10.

FIG. 13 is a flowchart showing the loop processing shown in FIG. 10.

FIG. 14 shows saturation processing of the integrated circuit device according to one embodiment of the invention.

FIG. 15 is a timing chart showing the saturation processing shown in FIG. 14.

FIG. 16 is a flowchart showing the saturation processing shown in FIG. 14

FIG. 17 shows the supplying of register data in the integrated circuit device according to one embodiment of the invention.

FIG. 18 is a timing chart showing the supplying of register data shown in FIG. 17.

FIG. 19 shows the supplying of write data and a data address in the integrated circuit device according to one embodiment of the invention.

FIG. 20 is a timing chart showing the supplying of the write data and the data address shown in FIG. 19.

FIG. 21 is a flowchart showing the supplying of the write data and the data address shown in FIG. 19.

FIG. 22 shows a comparative example of one embodiment of the invention.

FIG. 23 shows a modification of one embodiment of the invention.

### DETAILED DESCRIPTION OF THE EMBODIMENT

The invention may provide an integrated circuit device which performs high-speed calculation processing with a minimum hardware scale.

According to one embodiment of the invention, there is provided an integrated circuit device having a CPU which executes given processing based on an instruction code, the integrated circuit device comprising:

an instruction code bus used to supply an instruction code to the CPU from a memory; and

an instruction code supply line used to supply an instruction code output from a coprocessor to the CPU,

the CPU including:

a fetch section which fetches an instruction code; and

an instruction code select circuit which receives an instruction code input through the instruction code bus and an instruction code supplied through the instruction code supply line, and supplies one of the instruction codes to the fetch section.

This enables the instruction code based on the calculation result of the coprocessor to be supplied to the CPU at one operating clock signal of the CPU, for example. This also allows the fetch section of the CPU to fetch the instruction code generated by the coprocessor. This also allows the CPU to perform processing such as saturation processing at high speed.

The integrated circuit device may further comprise:

an instruction code select signal supply line used to supply an instruction code select signal to the instruction code select circuit from the coprocessor,

wherein the instruction code select circuit supplies one of an instruction code input through the instruction code bus and an instruction code supplied through the instruction code supply line to the fetch section based on the instruction code select signal.

This enables the coprocessor to control selection of either the instruction code supplied from the coprocessor or the instruction code supplied through the instruction code bus as the instruction code fetched by the fetch section of the CPU.

According to one embodiment of the invention, there is provided an integrated circuit device having a CPU which executes given processing based on an instruction code, the integrated circuit device comprising:

an instruction address bus used to supply an instruction address to a memory; and

an instruction address supply line used to supply an instruction address output from a coprocessor to the CPU,

the CPU including:

a fetch section which fetches an instruction code; and

an instruction address select circuit which receives an instruction address supplied through the instruction address supply line and an instruction address supplied from the fetch section, and supplies one of the instruction addresses to the instruction address bus.

This enables the instruction address based on the calculation result of the coprocessor to be supplied to the CPU at one operating clock signal of the CPU, for example. This also allows the fetch section of the CPU to fetch the instruction code corresponding to the instruction address generated by the coprocessor.

The integrated circuit device may further comprise:

a program counter which outputs a count value for generating an instruction address; and

a count value supply line used to supply the count value to the coprocessor,

wherein the count value output from the program counter is supplied to the coprocessor through the count value supply line; and

wherein the fetch section generates an instruction address based on the count value output from the program counter, and supplies the generated instruction address to the instruction address select circuit.

This enables the coprocessor to generate the instruction address based on the count value supplied from the CPU, thereby allowing the CPU to perform complicated processing such as loop processing at high speed.

The integrated circuit device may further comprise:

an instruction address select signal supply line used to supply an instruction address select signal to the instruction address select circuit from the coprocessor;

wherein the instruction address select circuit supplies one of an instruction address supplied through the instruction address supply line and an instruction address supplied from the fetch section to the instruction address bus, based on the instruction address select signal.

This enables the coprocessor to control selection of either the instruction address supplied from the coprocessor or the instruction address supplied from the fetch section as the instruction address supplied to the instruction address bus.

The integrated circuit device may further comprise:

an instruction code bus used to supply an instruction code to the CPU from the memory; and

an instruction code supply line used to supply an instruction code output from the coprocessor to the CPU,

the CPU including:

an instruction code select circuit which receives an instruction code supplied through the instruction code supply line and an instruction code input through the instruction code bus, and supplies one of the instruction codes to the fetch section.

According to one embodiment of the invention, there is provided an integrated circuit device having a CPU which executes given processing based on an instruction code, the integrated circuit device comprising:

first and second register data supply lines used to respectively supply first and second register data output from a coprocessor to the CPU,

the CPU including:

a register file including a plurality of registers; and

a first register data select circuit which receives the first register data supplied through the first register data supply line and CPU internal data, and supplies one of the first register data and the CPU internal data to the register file, and

the second register data output from the coprocessor being supplied to the register file through the second register data supply line.

This enables the register data of the coprocessor to be supplied to the register file of the CPU at one operating clock signal of the CPU, for example.

The integrated circuit device may further comprise:

a first register data select signal supply line used to supply a first register data select signal to the first register data select circuit from the coprocessor,

wherein the first register data select circuit supplies one of the first register data and the CPU internal data to the register file based on the first register data select signal.

This enables the coprocessor to control selection of either the first register data supplied from the coprocessor or the data inside the CPU as the data supplied to the register file.

The integrated circuit device may further comprise:

a register number supply line used to supply a coprocessor designation register number which indicates one of the registers of the register file designated by the coprocessor to the register file from the coprocessor,

wherein the first register data select signal is supplied to the register file;

wherein the register file includes a register number select circuit which receives the coprocessor designation register number supplied from the coprocessor and an internal designation register number designated inside the CPU, and selectively outputs one of the coprocessor designation register number and the internal designation register number based on the first register data select signal; and

wherein at least one of the registers is write-enabled based on the register number selectively output from the register number select circuit.

This enables the coprocessor to control selection of either the coprocessor designation register number supplied from the coprocessor or the internal designation number of the CPU as the number of the register which stores the data supplied to the register file.

In this integrated circuit device,

the CPU may include a second register data select circuit which receives the second register data supplied through the second register data supply line as a first input and data supplied from the first register data select circuit as a second input, and supplies one of the first and second inputs to at least one of the registers.

This enables either the second register data supplied from the coprocessor or the data supplied from the first register data select circuit to be selected and supplied to the register file.

The integrated circuit device may further comprise:

a second register data select signal supply line used to supply a second register data select signal to the second register data select circuit from the coprocessor;

wherein the second register data select circuit supplies one of the first and second inputs from the second register data select circuit to at least one of the registers based on the second register data select signal.

This enables the coprocessor to control selection of either the second register data supplied from the coprocessor or the data supplied from the first register data select circuit as the data supplied to the register file.

According to one embodiment of the invention, there is provided an integrated circuit device having a CPU which executes given processing based on an instruction code, the integrated circuit device comprising:

a data address supply line used to supply a data address output from a coprocessor to the CPU,

the CPU including:

a load/store section which writes data into a memory by supplying a data address to the memory through a data address bus and supplying write data through a write data bus; and

a data address select circuit which receives a data address supplied through the data address supply line and a data address output from the load/store section, and supplies one of the data addresses to the data address bus.

This enables the data address generated by the coprocessor to be supplied to the data address bus at one operating clock signal of the CPU, for example.

The integrated circuit device may further comprise:

a data address select signal supply line used to supply a data address select signal to the data address select circuit from the coprocessor;

wherein the data address select circuit supplies one of a data address supplied through the data address supply line and an instruction address output from the load/store section to the data address bus, based on the data address select signal.

This enables the coprocessor to control selection of either the data address supplied from the coprocessor or the data address supplied from the load/store section as the data address supplied to the data address bus.

According to one embodiment of the invention, there is provided an integrated circuit device having a CPU which executes given processing based on an instruction code, the integrated circuit device comprising:

a write data supply line used to supply write data output from a coprocessor to the CPU,

the CPU including:

a load/store section which writes data into a memory by supplying a data address to the memory through a data address bus and supplying write data through a write data bus; and

a write data select circuit which receives write data supplied through the write data supply line and write data output from the load/store section, and supplies one of the write data to the write data bus.

This enables the write data generated by the coprocessor to be supplied to the write data bus at one operating clock signal of the CPU, for example.

The integrated circuit device may further comprise:

a write data select signal supply line used to supply a write data select signal to the write data select circuit from the coprocessor,

wherein the write data select circuit supplies one of write data supplied through the write data supply line and write data output from the load/store section to the write data bus based on the write data select signal.

This enables the coprocessor to control selection of either the write data supplied from the coprocessor or the write data supplied from the load/store section as the write data supplied to the write data bus.

According to one embodiment of the invention, there is provided an integrated circuit device having a CPU which executes given processing based on an instruction code, the integrated circuit device comprising:

a read data supply line used to supply read data output from a coprocessor to the CPU,

the CPU including:

a load/store section which reads data from a memory by supplying a data address to the memory through a data address bus and receiving read data through a read data bus; and

a read data select circuit which receives read data supplied through the read data supply line and read data supplied from the read data bus, and supplies one of the read data to the load/store section.

This enables the read data generated by the coprocessor to be supplied to the load/store section at one operating clock signal of the CPU, for example.

The integrated circuit device may further comprise:

a read data select signal supply line used to supply a read data select signal to the read data select circuit from the coprocessor,

wherein the read data select circuit supplies one of read data output from the coprocessor and read data output from the CPUT to the load/store section, based on the read data select signal.

This enables the coprocessor to control selection of either the read data supplied from the coprocessor or the read data supplied through the read data bus as the read data supplied to the load/store section. This also enables the coprocessor to control selection of either the data address supplied from the coprocessor or the data address supplied from the load/store section as the data address supplied to the data address bus.

In this integrated circuit device,

the CPU may include:

an ALU which performs calculation processing based on an instruction code;

a first flag data supply line used to supply first flag data to the coprocessor, based on calculation result of the ALU; and

a second flag data supply line used to supply second flag data to the ALU, based on calculation result of the coprocessor; and

the ALU may include:

a flag register which stores the first or second flag data; and

a flag data select circuit which receives the first and second flag data through the first and second flag data supply lines, and supplies one of the first and second flag data to the flag register.

This enables the coprocessor to perform processing based on the first flag data supplied from the CPU. This enables the CPU to perform processing based on the second flag data based on the processing result of the coprocessor. Moreover, the integrated circuit device can perform saturation processing based on the first flag data at high speed.

In this integrated circuit device,

the CPU may include a flag data select signal supply line used to supply a flag data select signal to the ALU from the coprocessor; and

the flag data select circuit of the ALU may selectively output one of the first and second flag data to the flag register, based on the flag data select signal supplied through the flag data select signal supply line.

This enables the coprocessor to control selection of either the second flag data supplied from the coprocessor or the first flag data supplied from the ALU as the flag data supplied to the flag register.

These embodiments of the invention will be described in detail below, with reference to the drawings. Note that the embodiments described below do not in any way limit the scope of the invention laid out in the claims herein. In addition, not all of the elements of the embodiments described below should be taken as essential requirements of the invention. In the drawings, components denoted by the same reference numbers have the same meanings.

### 1. INTEGRATED CIRCUIT DEVICE

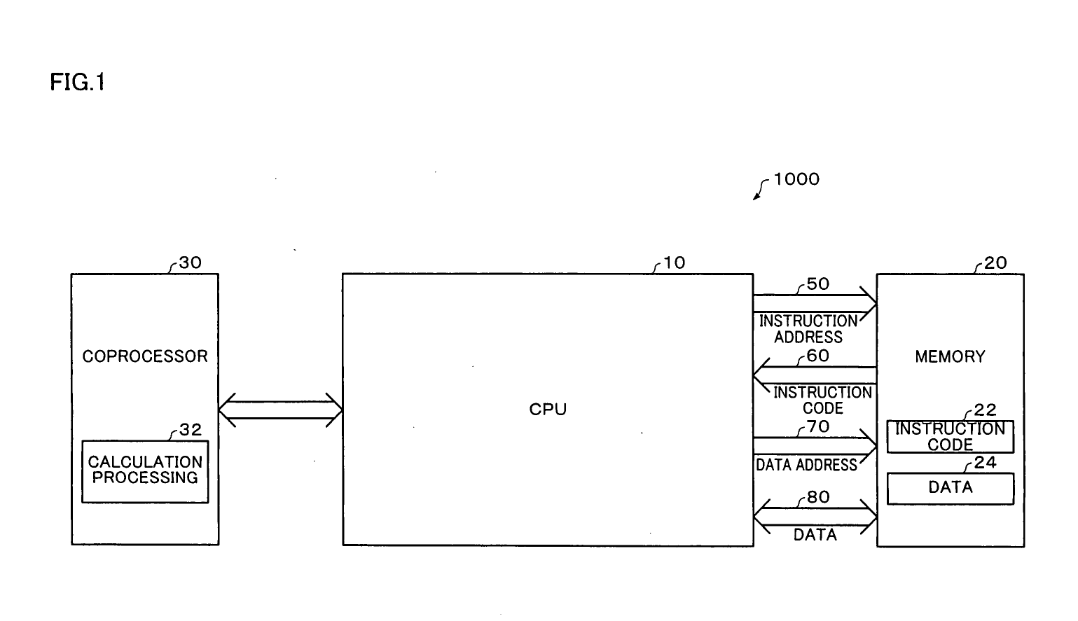

FIG. 1 is a configuration example of an integrated circuit device 1000 according to one embodiment of the invention. The integrated circuit device 1000 includes a central processing unit (CPU) 10, a memory 20, and a coprocessor 30. However, the configuration of the integrated circuit device 1000 is not limited thereto. For example, the integrated circuit device 1000 may have a configuration in which the memory 20 and the coprocessor 30 are omitted. The CPU 10 exchanges various types of information with the coprocessor 30. An instruction code 22 and data 24 processed by the CPU 10 are stored in the memory 20, for example.

The memory 20 receives an instruction address from the CPU 10 through an instruction address bus 50, and outputs the instruction code stored in the memory 20 to the CPU 10 through an instruction data bus 60 according to the instruction address, for example. The memory 20 receives a data address from the CPU 10 through a data address bus 70, and outputs the data 24 stored in the memory 20 to the CPU 10 through a data bus 80 according to the data address, for example. The instruction address may be supplied to the memory 20 through the data address bus 70, or the instruction code may be supplied to the CPU 10 through the data bus 80. The CPU 10 performs various types of processing based on the information obtained from the memory 20 as described above. The memory 20 can also store data output from the CPU 10 through the data bus 80, for example.

The coprocessor 30 includes a calculation processing section 32 which can perform calculation in which the CPU 10 is weak at high speed. Specifically, the CPU 10 can efficiently perform processing by using the coprocessor 30 depending on the type of processing.

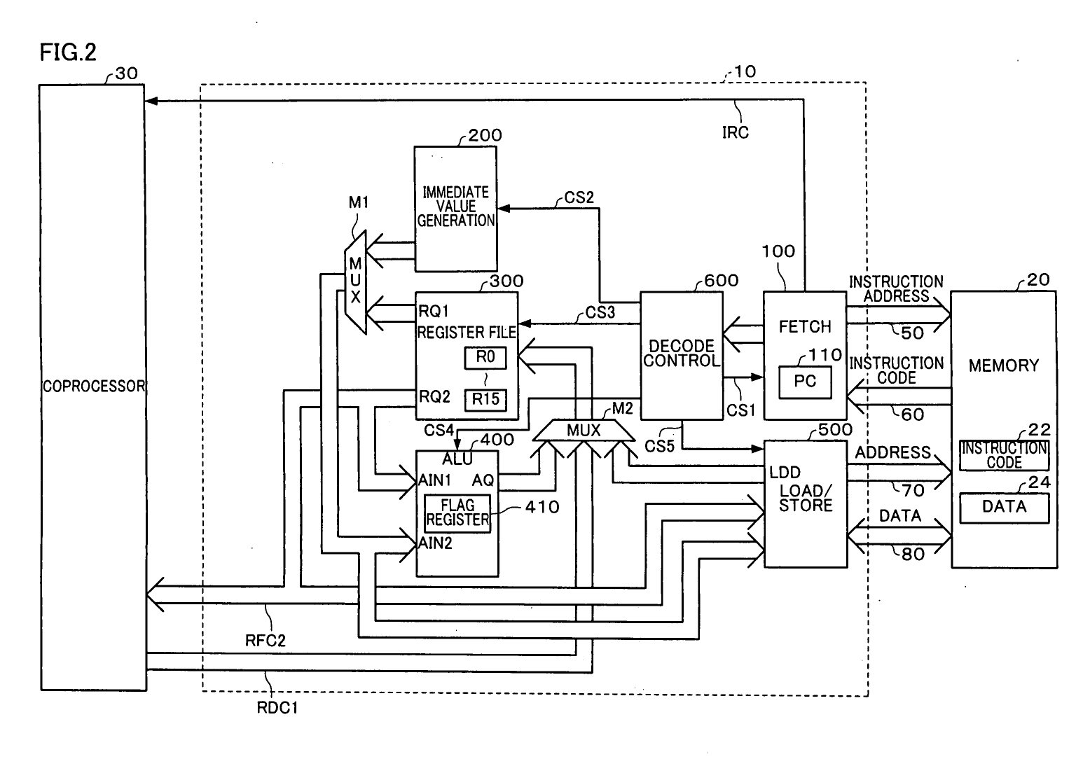

FIG. 2 is a configuration example of the CPU 10 according to one embodiment of the invention. In FIG. 2, the connection between the CPU 10 and the coprocessor 30 is partly omitted for convenience of description of the configuration of the CPU 10. The CPU 10 includes a fetch section 100 which fetches an instruction, an immediate value generation section 200 which generates an immediate value, and a register file 300 which includes a plurality of registers. The CPU 10 also includes an arithmetic and logic unit (ALU) 400 which performs calculation, a load/store section 500 which reads or writes data, and a decode control section 600 which decodes the instruction fetched by the fetch section 100.

The fetch section 100 fetches the instruction code 22 stored in the memory 20, for example. The fetch section 100 includes a program counter 110 which outputs a count value PC. When fetching an instruction, the fetch section 100 outputs an instruction address based on the count value output from the program counter 110 to the memory 20, for example. When fetching an instruction, the fetch section 100 outputs the value output from the program counter 110 to the memory 20 as an instruction address through the instruction address bus 50, for example. When fetching an instruction, the fetch section 100 may output the count value as an instruction address and then increment the count value of the program counter 110, or may output a value obtained by incrementing the count value of the program counter 110 as an instruction address, for example.

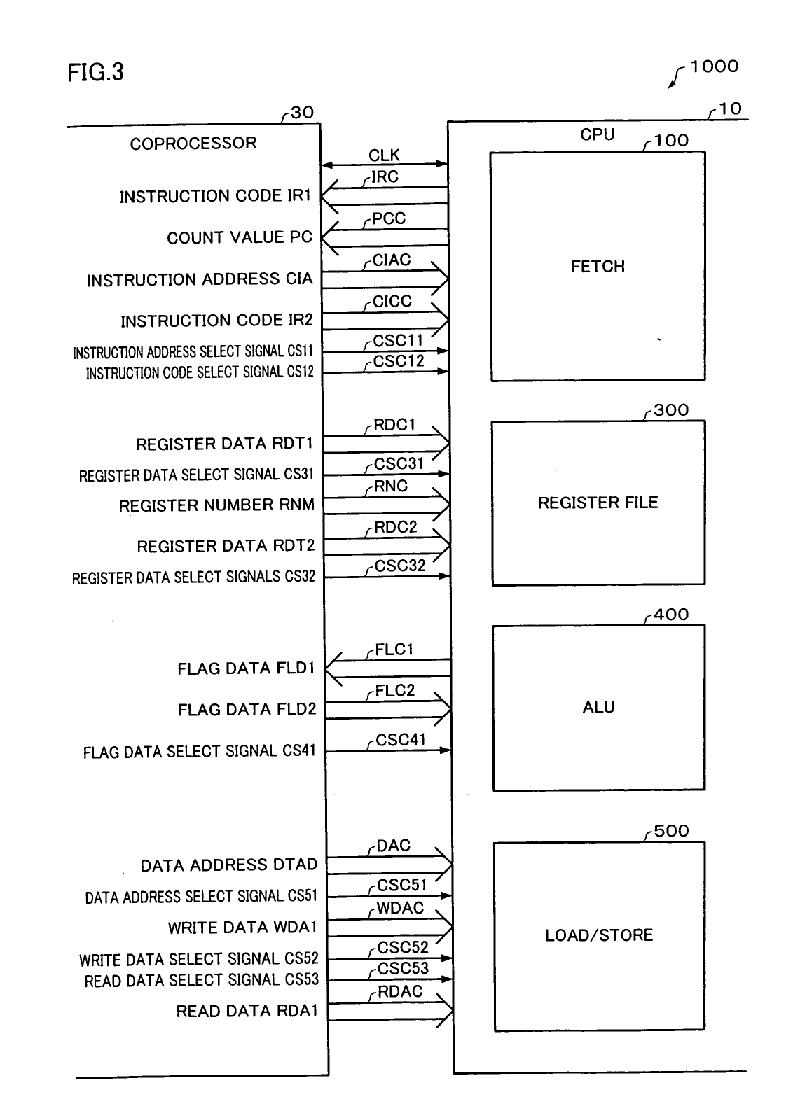

The fetch section 100 outputs the fetched instruction code 22 to the decode control section 600. The program counter 110 of the fetch section 100 is connected with one end of a count value supply line PCC (see FIG. 3, for example) (omitted in FIG. 2). The program counter 110 may be connected with the coprocessor 30 through the count value supply line PCC. In this case, the program counter 110 of the fetch section 100 may supply the count value PC to the coprocessor 30 through the count value supply line PCC. The fetch section 100 fetches the next instruction based on a control signal CS1 from the decode control section 600, for example.

When an immediate value is included in the instruction code 22, the immediate value generation section 200 generates 32-bit immediate data based on a control signal CS2 output from the decode control section 600, for example. The immediate data generated by the immediate value generation section 200 is supplied to the ALU 400 and the load/store section 500 through a multiplexer (MUX) M1.

The register file 300 includes a plurality of registers such as sixteen registers R0 to R15. Each of the registers R0 to R15 is a 32-bit register. However, the number of bits of each register is not limited thereto. The register file 300 selects an arbitrary register from the registers R0 to R15 based on a control signal CS3 output from the decode control section 600, and outputs a value stored in the selected register, for example.

An output terminal RQ1 of the register file 300 is connected with the multiplexer M1, for example. A value output from the output terminal RQ1 is supplied to the ALU 400 and the load/store section 500 through the multiplexer M1.

An output terminal RQ2 of the register file 300 is connected with the ALU 400 and the load/store section 500, for example. A value stored in the register selected based on the control signal CS3 is output from the output terminal RQ2. At least one of the registers R0 to R15 of the register file 300 may be set as a fixed register.

The ALU 400 includes a first ALU input terminal AIN1 and a second ALU input terminal AIN2, for example. A value output from the output terminal RQ2 of the second register select circuit 320 is input to the first ALU input terminal AIN1, and an output from the multiplexer M1 is input to the second ALU input terminal AIN2, for example. The ALU 400 performs calculation processing for the values input to the input terminals AIN1 and AIN2 based on a control signal CS4 output from the decode control section 600, and outputs the calculation result from an ALU output terminal AQ. The ALU output terminal AQ is connected with a multiplexer M2, for example.

The ALU 400 includes a flag register 410. The flag register 410 stores flag data such as a carry flag C (hereinafter also called “C flag”), overflow flag V, zero flag Z, and negative flag N. The output terminal of the flag register 410 is connected with one end of the flag register supply line FLC1 (first flag register supply line in a broad sense) (see FIG. 3, for example) (omitted in FIG. 2). The flag register 410 of the ALU 400 may be connected with the coprocessor 30 through a flag register supply line FLC1. In this case, the flag data C, V, Z, and N stored in the flag register 410 may be supplied to the coprocessor 30.

The load/store section 500 receives the value output from the multiplexer M1 or the value output from the output terminal RQ2 of the register file 300, and stores (writes) the value in the memory 20 based on a control signal CS5 output from the decode control section 600. The load/store section 500 reads data from the memory 20 based on the control signal CS5, and outputs the read data to the multiplexer M2 from a load data output terminal LDD, for example.

The decode control section 600 receives the instruction code 22 from the fetch section 100, decodes the instruction code 22, generates control signals based on the decode result, and outputs the control signals CS1 to CS5. The decode control section 600 also generates signals (not shown) for controlling the multiplexers M1 and M2.

The calculation result of the coprocessor 30 is supplied to the CPU 10 through a first register data supply line RDC1, for example. The calculation result of the coprocessor 30 may also be supplied through another line. The instruction code 22 is supplied to the coprocessor 30 from the fetch section 100 through an instruction code input line IRC, for example. The instruction code 22 may also be supplied to the coprocessor 30 through another line.

The above-described configuration is only one example of the configuration of the CPU 10. The configuration of the CPU 10 is not limited to the above-described configuration.

### 2. CONNECTION RELATIONSHIP OF EACH SECTION

FIG. 3 is a diagram illustrative of the connection relationship between the CPU 10 and the coprocessor 30.

The integrated circuit device 1000 includes an instruction address supply line CIAC for supplying an instruction address CIA generated by the coprocessor 30 to the CPU 10, and an instruction code supply line CICC for supplying an instruction code IR2 generated by the coprocessor 30 to the CPU 10. The integrated circuit device 1000 includes an instruction address select signal supply line CSC11 for supplying the instruction address CIA supplied from the coprocessor 30 to the CPU 10, and an instruction address select signal supply line CSC12 for supplying the instruction code IR2 supplied from the coprocessor 30 to the CPU 10.

The integrated circuit device 1000 includes first and second register data supply lines RDC1 and RDC2 for respectively supplying first and second register data RDT1 and RDT2 of the coprocessor 30 to the CPU 10. The integrated circuit device 1000 includes a first register data select signal supply line CSC31 for supplying a first register data select signal CS31 to the CPU 10, and a second register data select signal supply line CSC32 for supplying a second register data select signal CS32 to the CPU 10.

The first register data select signal CS31 is a signal for selecting either the first register data RDT1 of the coprocessor 30 or the data in the CPU 10, for example. The second register data select signal CS32 is a signal for selecting either the second register data RDT2 of the coprocessor 30 or the data in the CPU 10, for example.

The integrated circuit device 1000 includes a register number supply line RNC for supplying a register number RNM (coprocessor designation register number in a broad sense) designated by the coprocessor 30 to the CPU 10. The register number RNM indicates the number of the register in which the first register data RDT1 is stored, for example.

The integrated circuit device 1000 includes a second flag data supply line FLC2 for supplying flag data FLD2 (second flag data in a broad sense) based on the calculation result of the coprocessor 30 to the CPU 10. The integrated circuit device 1000 includes a flag data select signal supply line CSC41 for supplying a flag data select signal CS41 for selecting one of flag data FLD1 based on the calculation result of the ALU 400 of the CPU 10 and the flag data FLD2 based on the calculation result of the coprocessor 30.

The integrated circuit device 1000 includes a data address supply line DAC for supplying a data address DTAD generated by the coprocessor 30 to the CPU 10. The integrated circuit device 1000 includes a write data supply line WDAC for supplying write data WDA1 generated by the coprocessor 30 to the CPU 10, and a read data supply line RDAC for supplying read data RDA1 generated by the coprocessor 30 to the CPU 10.

The integrated circuit device 1000 includes a data address select signal supply line CSC51 for supplying to the CPU 10 a data address select signal CS51 for selecting either the data address DTAD supplied from the coprocessor 30 or a data address CDAD generated in the CPU 10. The integrated circuit device 1000 includes a write data select signal supply line CSC52 for supplying to the CPU 10 a write data select signal CS52 for selecting either the write data WDA1 supplied from the coprocessor 30 or write data WDA2 generated in the CPU 10. The integrated circuit device 1000 includes a read data select signal supply line CSC53 for supplying to the CPU 10 a read data select signal CS53 for selecting either the read data RDA1 supplied from the coprocessor 30 or read data RDA2 generated in the CPU 10.

When one end of the instruction code input line IRC is connected with the fetch section 100 and the other end of the instruction code input line IRC is connected with the coprocessor 30, the coprocessor 30 can receive the instruction code 22 (IR1) output from the fetch section 100. This allows the coprocessor 30 to acquire the instruction code 22 output from the fetch section 100 at one operating clock signal of the CPU 10. The instruction code 22 has a 32-bit configuration. However, the number of bits of the instruction code 22 is not limited thereto.

When the other end of the count value supply line PCC is connected with the coprocessor 30, the coprocessor 30 can receive the count value output from the program counter 110. This allows the coprocessor 30 to acquire the count value output from the program counter 110 at one operating clock signal of the CPU 10.

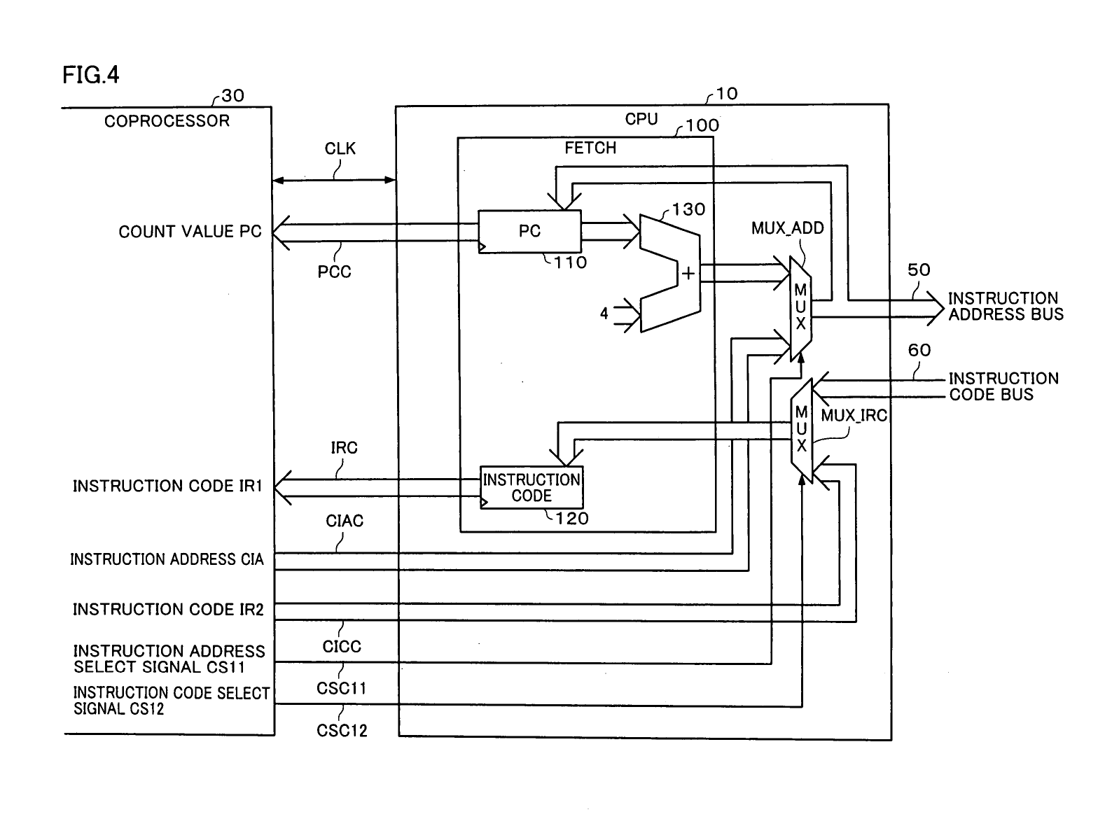

FIG. 4 is a block diagram showing the connection between the fetch section 100 of the CPU 10 and the coprocessor 30.

The CPU 10 includes the fetch section 100, an instruction code select circuit MUX_IRC, and an instruction address select circuit MUX_ADD, for example. Note that the instruction code select circuit MUX_IRC or the instruction address select circuit MUX_ADD may be omitted. The fetch section 100 includes the program counter 110, an instruction code register 120, and a calculator 130, for example. The calculator 130 may be either an adder or a subtractor.

The CPU 10 and the coprocessor 30 operate in synchronization with a clock signal CLK, for example.

In the CPU 10, the count value PC is output from the program counter 110 of the fetch section 100. The calculator 130 receives the output count value PC, adds a value such as four to the count value PC, and outputs the addition result. The value output from the calculator 130 is input to one input terminal of the instruction address select circuit MUX_ADD, and the instruction address CIA is input to the other input terminal of the instruction address select circuit MUX_ADD from the coprocessor 30 through the instruction address supply line CIAC.

The instruction address select circuit MUX_ADD selects either the value output from the calculator 130 or the instruction address CIA based on the instruction address select signal CS11 supplied from the coprocessor 30 through the instruction address select signal supply line CSC11, and supplies the selected value to the instruction address bus 50. Specifically, the instruction address select circuit MUX_ADD supplies either the instruction address CIA supplied from the coprocessor 30 or the value output from the fetch section 100 to the instruction address bus 50. This allows the coprocessor 30 to change the instruction code 22 supplied to the CPU 10.

The output from the instruction address select circuit MUX_ADD is also input to the program counter 110. The program counter 110 stores the value output from the instruction address select circuit MUX_ADD based on the clock signal CLK, for example. The count value PC output from the program counter 110 is supplied to the coprocessor 30 through the count value supply line PCC.

The instruction code 22 based on the instruction address supplied to the instruction address bus 50 is input to one input terminal of the instruction code select circuit MUX_IRC through the instruction code bus 60, for example. The instruction code IR2 supplied from the coprocessor 30 through the instruction code supply line CICC is input to the other input terminal of the instruction code select circuit MUX_IRC. The instruction code select circuit MUX_IRC selects either the instruction code 22 or the instruction code IR2 based on the instruction code select signal CS12 supplied from the coprocessor 30 through the instruction code select signal supply line CSC12, and supplies the selected instruction code to the instruction code register 120 of the fetch section 100.

Specifically, the instruction code IR2 generated by the coprocessor 30 can be stored in the instruction code register 120 of the fetch section 100. This allows the coprocessor 30 to direct the CPU 10 to perform a certain type of processing. The instruction code stored in the instruction code register 120 is supplied to the coprocessor 30 through the instruction code input line IRC.

The coprocessor 30 can supply the instruction address CIA, the instruction code IR2, the instruction address select signal CS11, and the instruction address select signal CS12 to the CPU 10 at one operating clock signal of the CPU 10. The instruction address select signal CS11 and the instruction address select signal CS12 may be generated in the CPU 10.

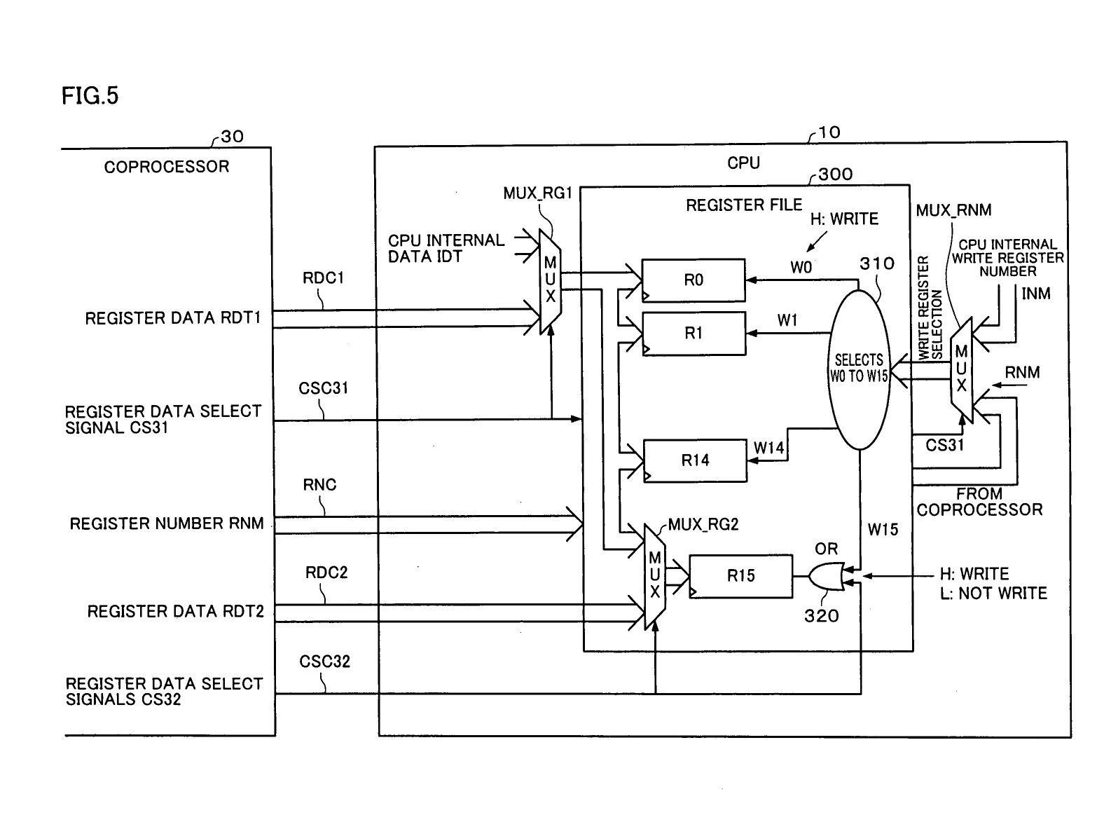

FIG. 5 is a block diagram showing the connection between the register file 300 of the CPU 10 and the coprocessor 30.

The CPU 10 includes the register file 300, a register data select circuit MUX_RG1 (first register data select circuit in a broad sense), and register number select circuit MUX_RNM, for example. The register data select circuit MUX_RG1 may be omitted, for example. The register file 300 includes a register data select circuit MUX_RG2 (second register data select circuit in a broad sense), the registers R0 to R15, a register select section 310, and the logic circuit 320, for example. The registers R0 to R15 are illustrated in FIG. 5. The number of registers may be set at an arbitrary number such as “32”. The register data select circuit MUX_RG2 may be omitted, for example. The register data select circuit MUX_RG1 shown in FIG. 5 corresponds to the multiplexer M2 shown in FIG. 2.

The first register data RDT1 is input to one input terminal of the register data select circuit MUX_RG1 from the coprocessor 30 through the first register data supply line RDC1. Internal data IDT of the CPU 10 is input to the other input terminal of the register data select circuit MUX_RG1. The internal data IDT of the CPU 10 corresponds to data output from the ALU 400 and data output from the output terminal LDD of the load/store section 500, for example. However, the internal data IDT is not limited thereto.

The first register data select signal CS31 is supplied to the CPU 10 through the first register data select signal supply line CSC31. The register data select circuit MUX_RG1 supplies either the internal data IDT of the CPU 10 or the first register data RDT1 from the coprocessor 30 to at least one of the registers R0 to R15 of the register file 300 based on the first register data select signal CS31. The register data select circuit MUX_RG2 is provided between the register R15 and the register data select circuit MUX_RG1, for example. Note that the register data select circuit MUX_RG2 may be provided between one of the registers R0 to R14 and the register data select circuit MUX_RG1, or a plurality of register data select circuits MUX_RG2 may be provided.

The register data select circuit MUX_RG2 receives the output from the register data select circuit MUX_RG1 and the second register data RDT2 supplied from the coprocessor 30 through the second register data supply line RDC2, and selects and outputs either the output from the register data select circuit MUX_RG1 or the second register data RDT2 to the register R15, for example. The register data select circuit MUX_RG2 selects either the output from the register data select circuit MUX_RG1 or the register data RDT2 based on the second register data select signal CS32 supplied from the coprocessor 30 through the second register data select signal supply line CSC32.

The register data select signals CS31 and CS32 may be generated inside the CPU 10.

The register number RNM (coprocessor designation register number in a broad sense) designated by the coprocessor 30 is supplied to the CPU 10 from the coprocessor 30 through the register number supply line RNC. The register number RNM is supplied to one input terminal of the register number select circuit MUX_RNM. A register number INM (internal designation register number in a broad sense) designated inside the CPU 10 is supplied to the other input terminal of the register number select circuit MUX_RNM. The register number select circuit MUX_RNM selects one of the register numbers RNM and INM based on the register data select signal CS31, and supplies the selected register number to the register select section 310 of the register file 300, for example.

The register select section 310 selects one of write enable signal lines W0 to W15 based on the register number output from the register number select circuit MUX_RNM, and supplies an active signal (e.g. high-level signal) to the selected write enable signal line. In FIG. 5, the write enable signal line W0 corresponds to the register R0, and the write enable signal line W1 corresponds to the register R1, for example. Likewise, the write enable signal lines W2 to W15 correspond to the registers R2 to R15, respectively. The registers R0 to R15 are write-enabled when the signals supplied to the write enable signal lines W0 to W15 are set to active, respectively. The term “write-enabled” indicates a state in which each of the registers R0 to R15 can store data supplied thereto.

The registers R0 to R15 store register data supplied through the register select circuit MUX_RG1 or MUX_RG2 based on the signals supplied to the write enable signal lines W0 to W15, respectively. For example, when a signal set to active is supplied to the write enable signal line W0, the register R0 stores register data supplied through the register select circuit MUX_RG1.

A logic circuit 320 is connected with the register R15 which is connected with the register data select circuit MUX_RG2, for example. The write enable signal line W15 and the register data select signal supply line CSC32 are connected with the logic circuit 320. For example, when a signal set to active is supplied to the write enable signal line W15, the register R15 is write-enabled. This causes the register R15 to store register data supplied through the register select circuit MUX_RG2. The register R15 is also write-enabled when the register data select signal CS32 supplied through the register data select signal supply line CSC32 is set to active. Specifically, the register R15 connected with the register select circuit MUX_RG2 is write-enabled when at least one of the signal supplied to the write enable signal line W15 and the register data select signal CS32 is set to active.

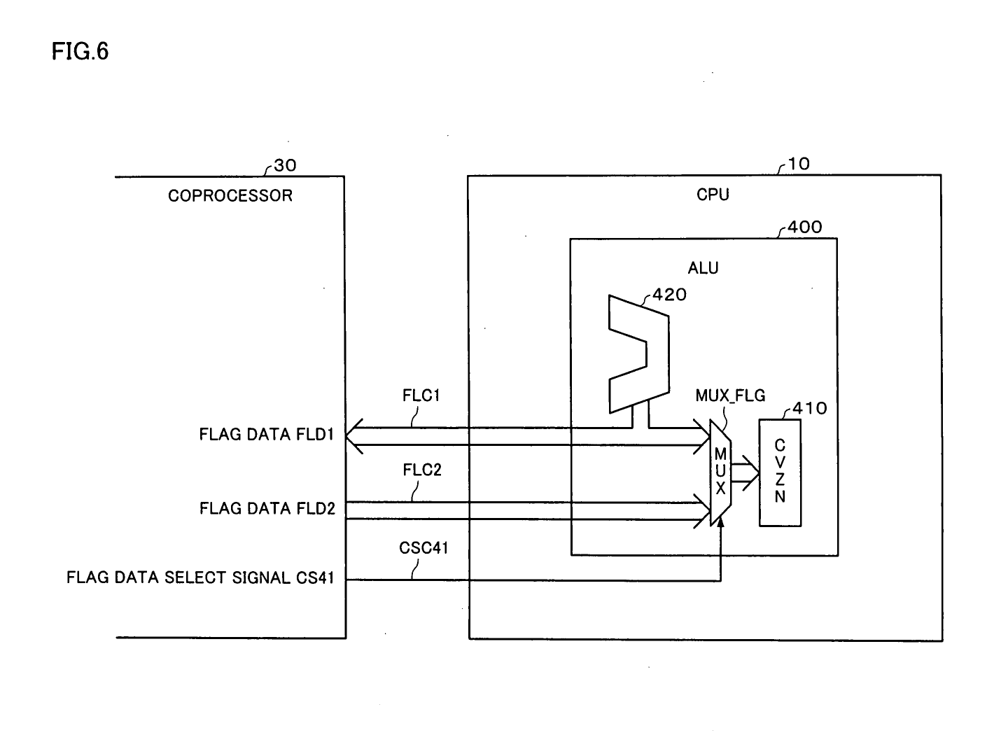

FIG. 6 is a block diagram showing the connection between the ALU 400 of the CPU 10 and the coprocessor 30. The ALU 400 includes the flag register 410, a calculation processing section 420 which performs calculations, and a flag data select circuit MUX_FLG The flag data FLD1 (first flag data in a broad sense) based on the calculation result of the calculation processing section 420 is supplied to the coprocessor 30 through the flag data supply line FLC1 (first flag data supply line in a broad sense).

The flag data FLD1 and the flag data FLD2 (second flag data in a broad sense) supplied through the flag data supply line FLC2 (second flag data supply line in a broad sense) are supplied to the flag data select circuit MUX_FLG The flag data select circuit MUX_FLG selects either the flag data FLD1 or FLD2 based on the flag data select signal CS41 supplied from the coprocessor 30 through the flag data select signal supply line CSC41, and supplies the selected flag data to the flag register 410. The flag register 410 stores the value output from the flag data select circuit MUX_FLG

The flag data select signal CS41 may be generated inside the CPU 10.

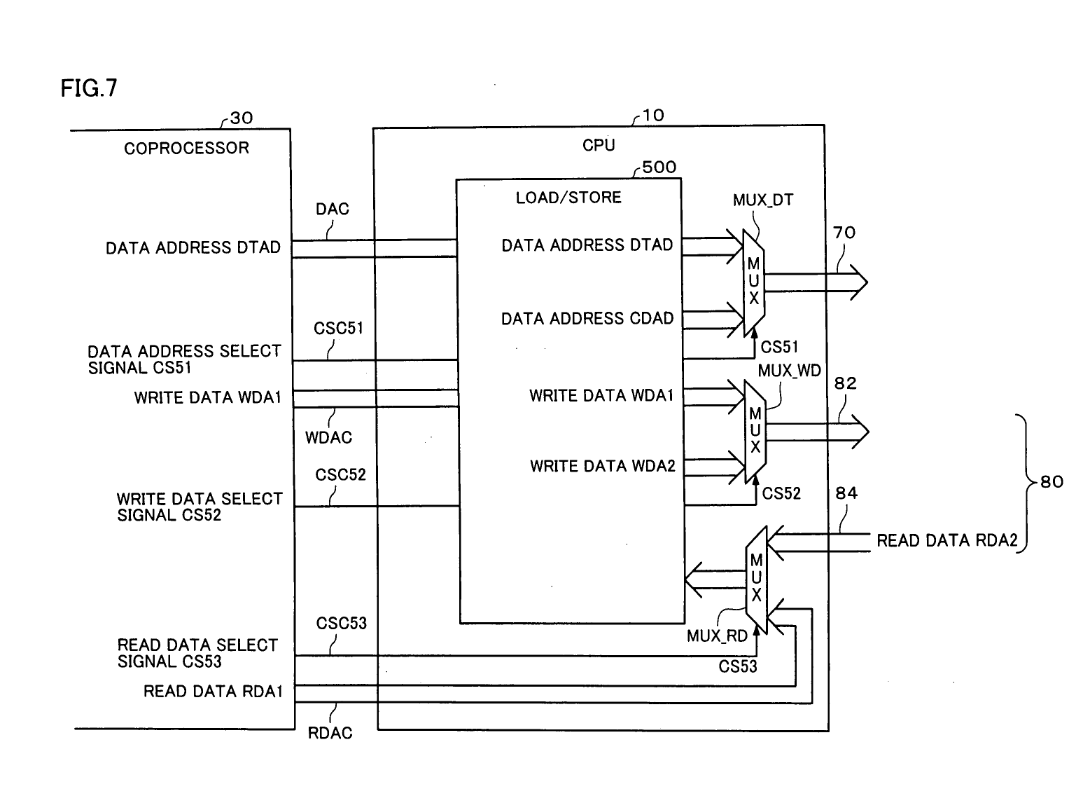

FIG. 7 is a block diagram showing the connection between the load/store section 500 of the CPU 10 and the coprocessor 30. The CPU 10 includes the load/store section 500, a data address select circuit MUX_DT, a write data select circuit MUX_WD, and a read data select circuit MUX_RD, for example. Note that the write data select circuit MUX_WD or the like may be omitted.

The data address DTAD for reading or writing data is supplied to the CPU 10 from the coprocessor 30 through the data address supply line DAC. The write data WDA1 is supplied to the CPU 10 from the coprocessor 30 through the write data supply line WDAC. The read data RDA1 is supplied to the CPU 10 from the coprocessor 30 through the read data supply line RDAC.

The load/store section 500 supplies the data address DTAD supplied from the coprocessor 30 and the data address CDAD generated inside the CPU 10 to the data address select circuit MUX_DT. The load/store section 500 supplies the write data WDA1 supplied from the coprocessor 30 and the write data WDA2 generated inside the CPU 10 to the write data select circuit MUX_WD.

The data address select signal CS51 is supplied to the CPU 10 from the coprocessor 30 through the data address select signal supply line CSC51. The write data select signal CS52 is supplied to the CPU 10 from the coprocessor 30 through the write data select signal supply line CSC52.

The address selection circuit MUX_DT selects either the data address DTAD or CDAD based on the data address select signal CS51 supplied from the coprocessor 30, and supplies the selected data address to the data address bus 70. The write data select circuit MUX_WD selects either the write data WDA1 or WDA2 based on the write data select signal CS52 supplied from the coprocessor 30, and supplies the selected write data to a write data bus 82 included in the data bus 80.

The read data RDA1 from the coprocessor 30 and the read data RDA2 supplied through the read data bus 84 included in the data bus 80 are supplied to the read data select circuit MUX_RD. The read data select signal CS52 is supplied to the CPU 10 from the coprocessor 30 through the read data select signal supply line CSC52.

The read data select circuit MUX_RD selects either the read data RDA1 or RDA2 based on the read data select signal CS53 supplied from the coprocessor 30, and supplies the selected read data to a read data bus 82.

The coprocessor 30 can supply the data address select signal CS51, the write data select signal CS52, and the read data select signal CS53 to the CPU 10 at one operating clock signal of the CPU 10. The data address select signal CS51, the write data select signal CS52, and the read data select signal CS53 may be generated inside the CPU 10.

This configuration allows the coprocessor 30 to designate an address or data for reading or writing of data performed by the CPU 10.

The CPU 10 and the coprocessor 30 operate based on the clock signal CLK. Note that the CPU 10 and the coprocessor 30 may operate based on different clock signals. The CPU 10 may have a configuration in which some of the above-described constituent elements are omitted.

### 3. INSTRUCTION DEFINITION AND INSTRUCTION EXAMPLE

3.1 Instruction Definition

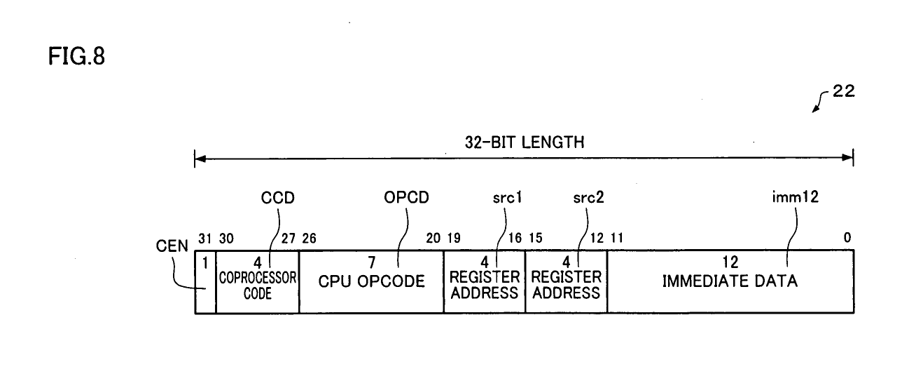

FIG. 8 is a diagram showing an example of the definition of the instruction code 22. The instruction code 22 includes a coprocessor enable bit CEN, a coprocessor code CCD, and a CPU opcode OPCD, for example. The coprocessor enable bit CEN indicates enabling or disabling of the coprocessor 30, the coprocessor code CCD indicates an instruction issued to the coprocessor 30, and the CPU opcode OPCD indicates an opcode for the CPU 10.

The instruction code 22 has a 32-bit configuration, for example. The 1-bit coprocessor enable bit CEN is set in the most significant bit (MSB) (e.g. 31st bit), the 4-bit coprocessor code CCD is set in the 30th to 27th bits, and the 7-bit CPU opcode OPCD is set in the 26th to 20th bits, for example. The operation of the coprocessor 30 is enabled when the coprocessor enable bit CEN is set at “1”, and the operation of the coprocessor 30 is disabled when the coprocessor enable bit CEN is set at “0”, for example. In the instruction code 22, the remaining 20 bits (i.e. 19th bit to the least significant bit (LSB) (0th bit)) are arbitrarily used by the CPU opcode OPCD.

For example, when an addition instruction “add” is set as the CPU opcode OPCD, four bits from the 19th bit to the 16th bit and four bits from the 15th bit to the 12th bit are used for register addresses src1 and src2, and twelve bits from the 11th bit to the 0th bit are used for immediate data imm12, as shown in FIG. 8.

The coprocessor 30 performs calculation processing based on the coprocessor code CCD.

The above-described configuration example of the instruction code 22 is only an example. The instruction may also be defined in another way.

3.2 Loop Processing

An example in which the coprocessor 30 performs loop calculation processing is described below.

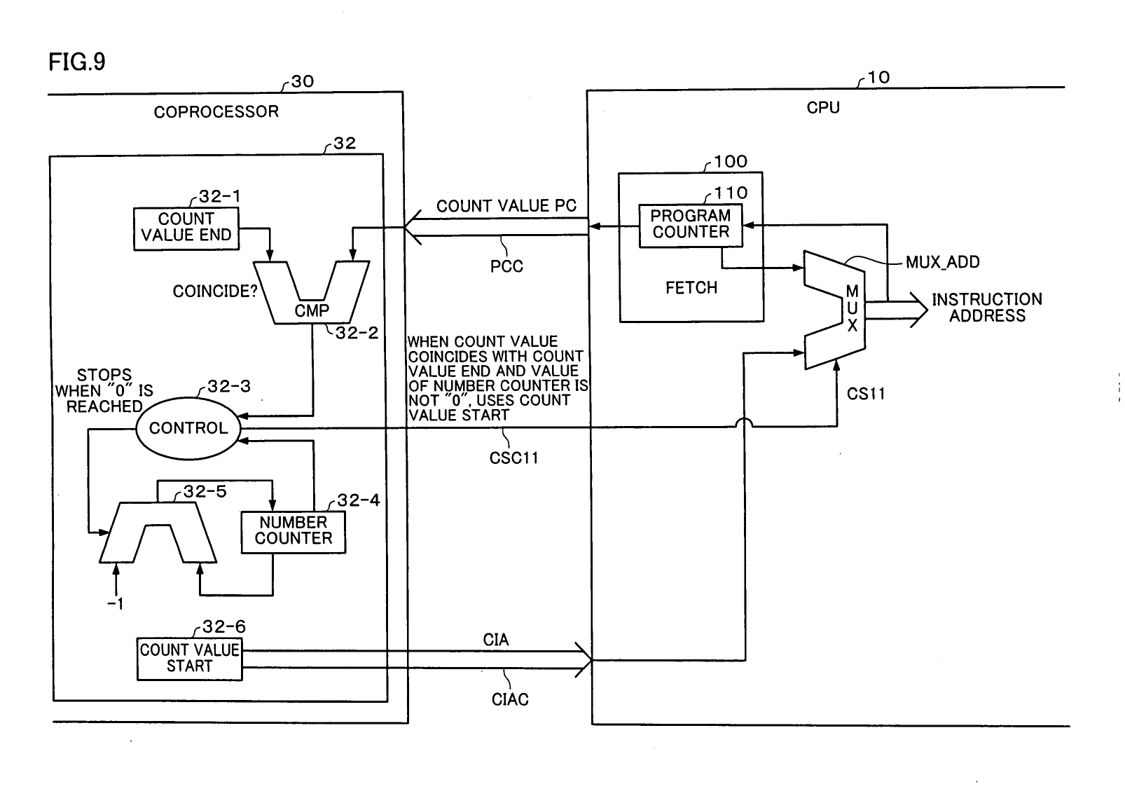

FIG. 9 is a configuration example of the coprocessor 30 which performs loop processing. The coprocessor 30 includes the calculation processing section 32. The calculation processing section 32 includes a count value end 32-1, a comparator 32-2, a control section 32-3, a number counter 32-4, a subtractor 32-5, and a count value start 32-6. However, the configuration of the calculation processing section 32 is not limited thereto. For example, the subtractor 32-5 may be an adder. The count value end 32-1 and the count value start 32-6 are formed by registers in which a given value is stored, for example. For example, a value corresponding to the end of the loop processing is stored in the count value end 32-1, and a value corresponding to the start of the loop processing is stored in the count value start 32-6.

The calculation processing section 32 receives the count value PC from the CPU 10, and compares the value stored in the count value end 32-1 and the count value PC using the comparator 32-2. When the comparator 32-2 has determined that the value stored in the count value end 32-1 coincides with the count value PC, the control section 32-3 outputs the instruction address select signal CS11 based on the value output from the number counter 32-4 to the CPU 10. In more detail, when the value output from the number counter 32-4 is not “0”, the control section 32-3 sets the instruction address select signal CS11 to active (e.g. high level) as a signal which causes the instruction address select circuit MUX_ADD of the CPU 10 to selectively output the value (instruction address CIA) stored in the count value start 32-6 output from the coprocessor 30. The control section 32-3 causes the subtractor 32-5 to subtract the value stored in the number counter 32-4.

On the other hand, when the value output from the number counter 324 is “0”, the control section 32-3 stops the subtraction processing of the subtractor 32-5 and sets the instruction address select signal CS11 to be a signal which causes the instruction address select circuit MUX_ADD to selectively output an instruction address output from the fetch section 100 of the CPU 10.

When the value stored in the count value start 32-6 is selected as an instruction address by the instruction address select circuit MUX_ADD, the instruction address is stored in the program counter 110. The CPU 10 sequentially processes the corresponding instruction code 22 while incrementing the value stored in the program counter 110, for example. The instruction address select circuit MUX_ADD changes the instruction address to be output based on the instruction address select signal CS 11 from the coprocessor 30. Specifically, when the coprocessor 30 has determined that one loop processing has been completed, the coprocessor 30 causes the instruction address select circuit MUX_ADD to select the output from the count value start 39-6. This causes the value of the count value start 32-6 to be output from the instruction address select circuit MUX_ADD, and causes the value of the count value start 32-6 to be also stored in the program counter 110. The loop processing starts again in this manner. The number of loops may be determined based on the value set in the number counter 32-4.

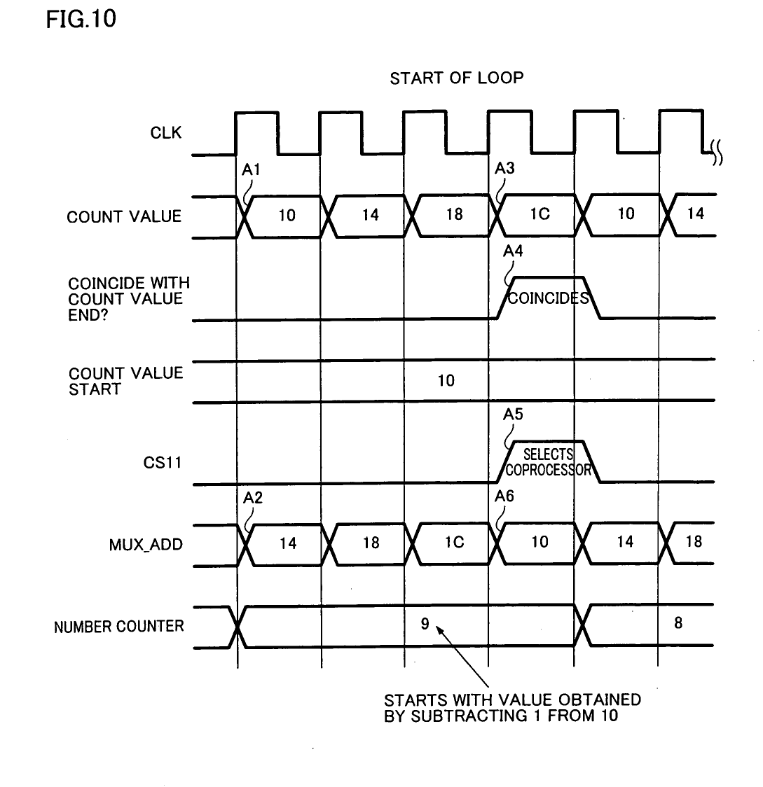

FIG. 10 is a timing chart showing the start state of the loop processing. In this example, a value “10” is stored in the count value start 32-6 as the loop processing start address, and a value “1C” is stored in the count value end 32-1 as the loop processing end address, for example. This example shows a configuration in which the loop processing is performed ten times. A value “9” is stored in the number counter 32-4, for example.

A value “10” is supplied to the coprocessor 30 from the program counter 110 as the count value PC at a timing indicated by A1. In this case, the count value PC is incremented by “4” in the fetch section 100, and a value “14” is supplied to the instruction address select circuit MUX_ADD from the fetch section 100 as an instruction address at a timing indicated by A2. Since “10” is stored in the count value start 32-6 as the loop processing start address, a value “10” is supplied to the instruction address select circuit MUX_ADD as the instruction address CIA, for example. In this case, since the instruction address select signal CS11 is set to inactive, the instruction address select circuit MUX_ADD selects the instruction address from the fetch section 100. Therefore, a value “14” is supplied to the instruction address bus 50 as an instruction address.

The above-described processing is repeatedly performed until the value “1C” stored in the count value end 32-1 coincides with the count value PC. In this period, the CPU 10 can perform processing based on the instruction code corresponding to the instruction address.

When the count value PC has become “1C” at a timing indicated by A3, the comparator 32-2 determines that the count value PC coincides with the value stored in the count value end 32-1 as indicated by A4. Since the value stored in the number counter 324 is not “0”, the control section 32-3 sets the instruction address select signal CS11 to active as indicated by A5. Therefore, the instruction address select circuit MUX_ADD selects the instruction address CIA, and supplies the value “10” stored in the count value start 32-6 to the instruction address bus 50. The program counter 110 stores the value “10” output from the instruction address select circuit MUX_ADD at a timing indicated by A6.

The processing of one loop is thus completed. The loop processing start address is then set as an instruction address so that the loop processing starts.

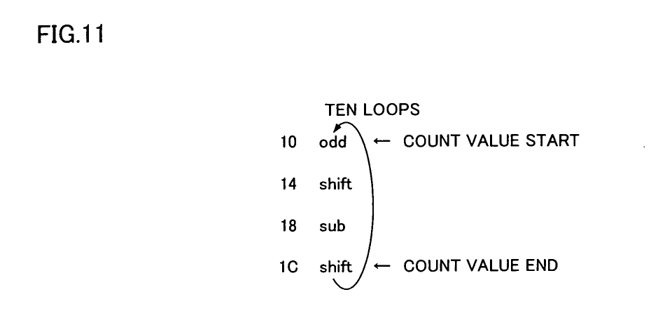

FIG. 11 shows an example of the instruction code corresponding to each instruction address. The loop processing as shown in FIG. 11 in which an “odd” instruction, a “shift” instruction, a “sub” instruction, and a “shift” instruction are repeatedly executed can be performed at high speed by respectively setting the count value end 32-1 and the count value start 32-6 of the coprocessor 30 at “1C” and “10”, for example. As indicated by A6 in FIG. 10, the interval between the instruction address of the CPU 10 is set from the loop processing end address “1C” to the next loop processing start address “10” is a zero clock signal based on the operating clock signal CLK of the CPU 10. In one embodiment of the invention, a predetermined time based on the clock signal CLK is not required for determining completion of the loop processing and branching based on the determination result in the loop processing as shown in FIG. 11, for example. Therefore, the loop processing can be performed at high speed.

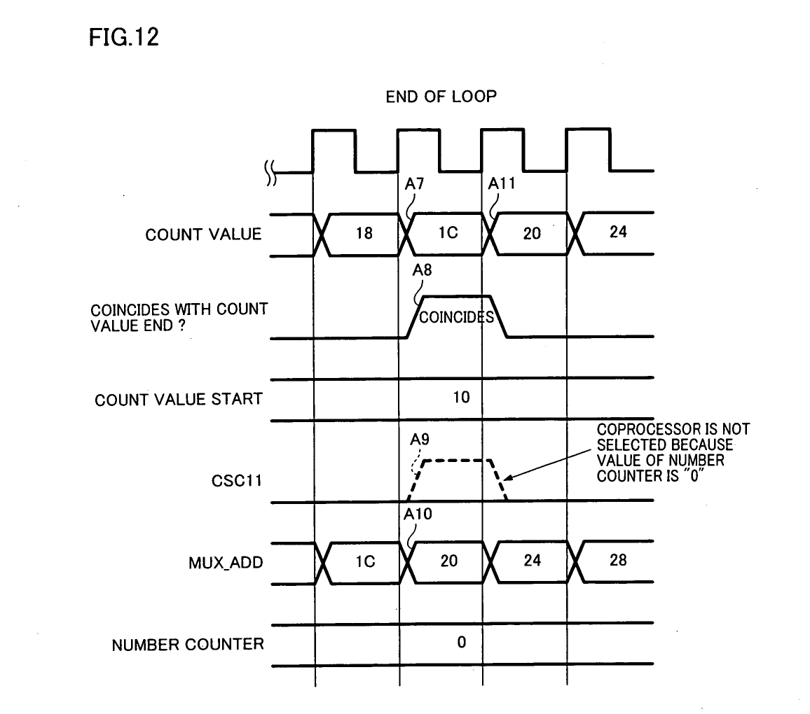

FIG. 12 is a timing chart showing the end state of the loop processing. When the count value PC has become “1C” at a timing indicated by A7, the comparator 32-2 determines that the count value PC coincides with the value stored in the count value end 32-1 as indicated by A8. The control section 32-3 sets the instruction address select signal CS11 based on the comparison result. In this case, since the value stored in the number counter 324 is “0”, the control section 32-3 sets the instruction address select signal CS11 to inactive instead of setting the instruction address select signal CS11 to active as indicated by A9. Therefore, the instruction address select circuit MUX_ADD does not select the instruction address CIA, but selects the instruction address supplied from the fetch section 100. In this case, since the count value PC is “1C”, the fetch section 100 supplies a value “20” obtained by incrementing “4” to the instruction address select circuit MUX_ADD as an instruction address. Therefore, the instruction address select circuit MUX_ADD supplies the value “20” supplied from the fetch section 100 to the instruction address bus 50. The program counter 110 stores the value “20” output from the instruction address select circuit MUX_ADD at a timing indicated by A11.

As indicated by A10 in FIG. 12, the interval between the instruction address of the CPU 10 is set from the loop processing end address “1C” to the next instruction address “20” is a zero clock signal based on the operating clock signal CLK of the CPU 10. In one embodiment of the invention, a predetermined time based on the clock signal CLK is not required for determining completion of the loop processing and branching based on the determination result in the loop processing as shown in FIG. 11, for example. Therefore, the loop processing can be performed at high speed.

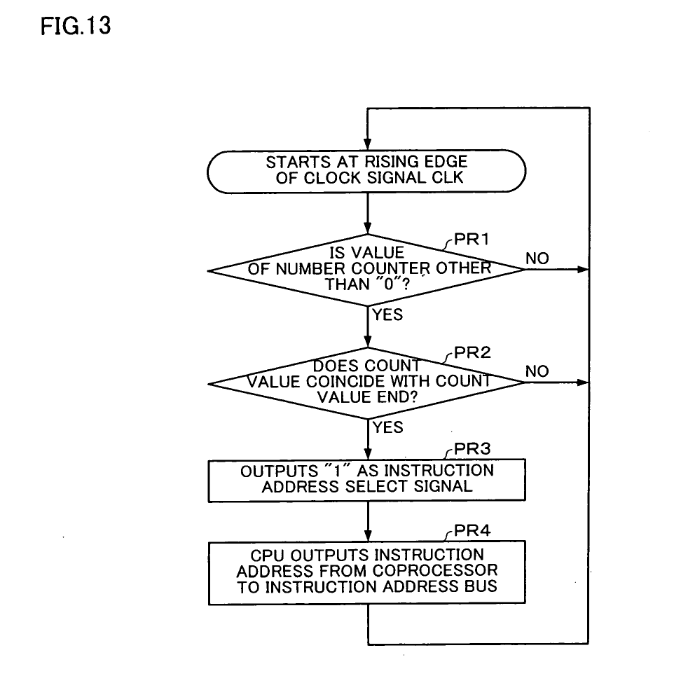

FIG. 13 is a flowchart showing the loop processing. Processing PR1 to PR3 indicates processing performed by the coprocessor 30, and processing PR4 indicates processing performed by the CPU 10. For example, the control section 32-3 may perform the processing PR1 to PR3. After the loop processing has started at the rising edge of the clock signal CLK, whether or not the value of the number counter 32-6 is “0” is determined in the processing PR1, for example. When the value of the number counter 32-6 is not “0”, the processing PR2 in the subsequent stage is performed.

In the processing PR2, whether or not the count value PC coincides with the value stored in the count value end 32-1 is determined. When the count value PC has been determined to coincide with the value stored in the count value end 32-1, the processing PR3 in the subsequent stage is performed.

In the processing PR3, the instruction address select signal CS11 is set at a logic “1”, for example. The instruction address select signal CS11 set at a logic “1” indicates a signal which causes the instruction address select circuit MUX_ADD to select the instruction address CIA.

In the processing PR4, the CPU 10 supplies the instruction address CIA supplied from the coprocessor 30 to the instruction address bus 50.

This enables the coprocessor 30 to determine the start of the loop processing, the loop processing end address, and the end of the loop processing.

3.3 Saturation Processing

An example in which the coprocessor 30 performs saturation processing is described below.

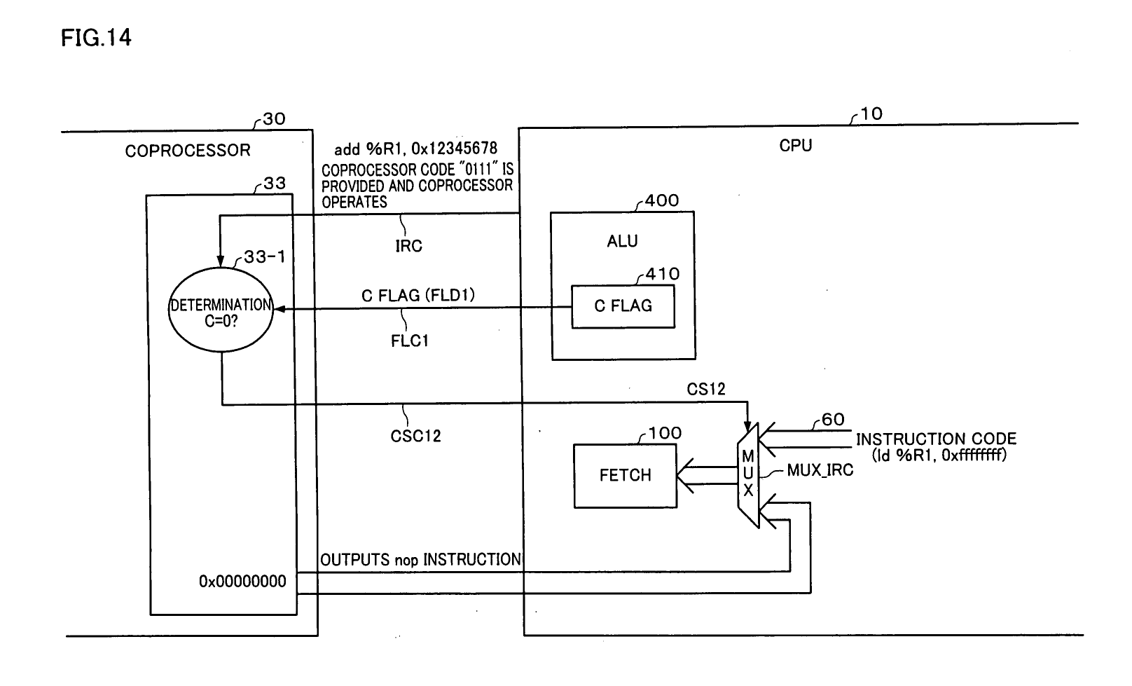

FIG. 14 is a configuration example of the coprocessor 30 which performs saturation processing. The coprocessor 30 includes a calculation processing section 33. The calculation processing section 33 includes a determination section 33-1, for example.

The determination section 33-1 receives the instruction code input from the CPU 10 through the instruction code input line IRC. The determination section 33-1 also receives the flag data FLD1 supplied through the flag data supply line FLC1. The flag data FLD1 supplied through the flag data supply line FLC1 includes the C flag.

When the coprocessor code CCD included in the instruction code supplied to the determination section 33-1 indicates processing by the calculation processing section 33, the determination section 33-1 determines whether or not the C flag is “0”. When the C flag is “0”, the determination section 33-1 supplies the activated instruction code select signal CS12 to the CPU 10 through the instruction code select signal supply line CSC12. In this case, the instruction code select circuit MUX_IRC of the CPU 10 receives the activated instruction code select signal CS12, selects the instruction code IR2 supplied from the coprocessor 30, and supplies the instruction code IR2 to the fetch section 100.

The calculation processing section 33 supplies an instruction (“nop” instruction) indicating not to perform processing to the CPU 10 as the instruction code IR2 through the instruction code supply line CICC. The instruction code of the “nop” instruction is set at “00000000”, for example.

An example in which a program made up of first and second instruction codes is executed in the order of the first and second instruction codes is described below.

The first instruction code is set so that the coprocessor code CCD indicates the calculation processing section 33, the CPU opcode OPCD is set to an “add” instruction, the address of the register R1 is set as the register address src1, and “12345678” is set as the immediate data imm12, for example. Note that “12345678” indicates an arbitrary value.

The second instruction code is set so that the coprocessor code CCD indicates the calculation processing section 33, the CPU opcode OPCD is set to a “ld” instruction, the address of the register R1 is set as the register address src1, and “FFFFFFFF” is set as the immediate data imm12, for example. In this example, “FFFFFFFF” indicates the maximum value when performing the saturation processing, for example. The saturation processing (round processing) is performed for the value which exceeds the maximum value.

In the CPU 10, when the first instruction code has been executed, the ALU 400 adds the value stored in the register R1 and “12345678” included in the instruction code based on the “add” instruction, for example. The addition result is stored in the register R1, for example. The flag data of the flag register 410 is set based on the above calculation result. For example, when an overflow has occurred by the addition processing, the C flag is set at “1”. The first instruction code is input to the coprocessor 30 through the instruction code input line IRC.

When the first instruction code has been input to the coprocessor 30, the calculation processing section 33 starts processing. The determination section 33-1 determines whether or not the C flag is “0”. When the C flag is “0”, the determination section 33-1 supplies the activated instruction code select signal CS12 to the CPU10.

In this case, the second instruction code supplied through the instruction code bus 60 and the “nop” instruction supplied from the coprocessor 30 are supplied to the instruction code select circuit MUX_IRC. The instruction code select circuit MUX_IRC supplies the “nop” instruction to the fetch section 100 based on the instruction code select signal CS12 set to active. This allows the “nop” instruction to be fetched by the fetch section 100 so that the “nop” instruction which directs the CPU 10 not to perform processing is executed as the next instruction step.

On the other hand, when the C flag is “1”, the instruction code select signal CS12 set to inactive is supplied to the CPU 10. The instruction code select circuit MUX_IRC then selects the second instruction code supplied through the instruction code bus 60, and supplies the second instruction code to the fetch section 100. This allows the second instruction code to be executed as the next instruction step. In this case, “FFFFFFFF” is stored in the register R1 based on the “ld” instruction. Therefore, when an overflow has occurred in the calculation result by the first instruction code, the calculation result can be set at a given value. The next instruction code can be canceled when an overflow has not occurred.

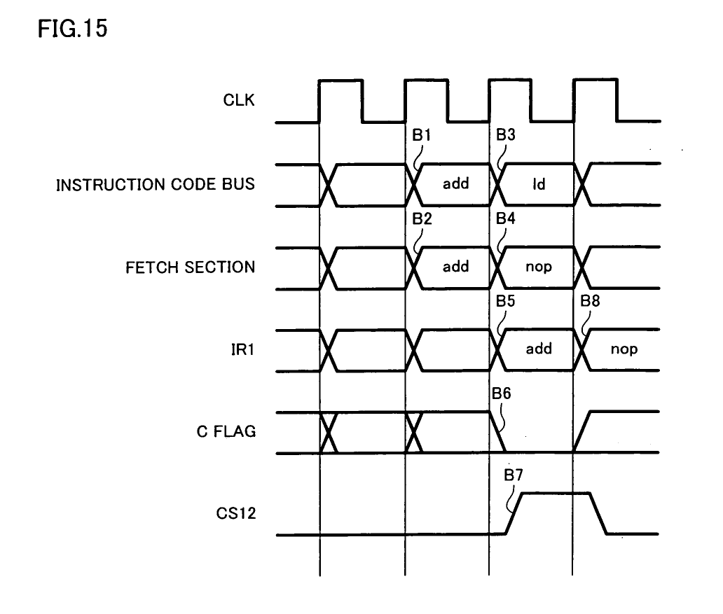

FIG. 15 is a timing chart showing fetching of the instruction code in the saturation processing shown in FIG. 14. FIG. 15 shows the case where an overflow has occurred in the calculation result of the ALU 400. The first instruction code (add) is supplied to the instruction code bus 60 at a timing indicated by B1, and the first instruction code (add) is fetched by the fetch section 100 as indicated by B2.

For example, the second instruction code (ld) is supplied to the instruction code bus 60 at a timing indicated by B3 in synchronization with the next rising edge of the clock signal CLK. However, the second instruction code (ld) is not fetched, and the “nop” instruction is fetched by the fetch section 100 as indicated by B4. This is because the instruction code IR2 from the coprocessor 30 has been selected by the instruction code select circuit MUX_IRC. The first instruction code (add) is executed by the CPU 10 and is input to the coprocessor 30 at a timing indicated by B5.

When the first instruction code (add) has been executed, the flag data is stored in the flag register 410 by the ALU 400. The flag data (e.g. C flag) is supplied to the coprocessor 30. When an overflow has occurred in the ALU 400, the C flag is set at “0” (e.g. low level) as indicated by B6. The determination section 33-1 sets the instruction code select signal CS12 to active (e.g. high level) based on the C flag as indicated by B7. The instruction code select circuit MUX_IRC selects the instruction code IR2 from the coprocessor 30 (“nop” instruction) based on the instruction code select signal CS12, and supplies the instruction code IR2 to the fetch section 100. Specifically, the fetch section 100 fetches the “nop” instruction as indicated by B4.

For example, the “nop” instruction is executed by the CPU 10 and the “nop” instruction is input to the coprocessor 30 as indicated by B8 in synchronization with the next rising edge of the clock signal CLK.

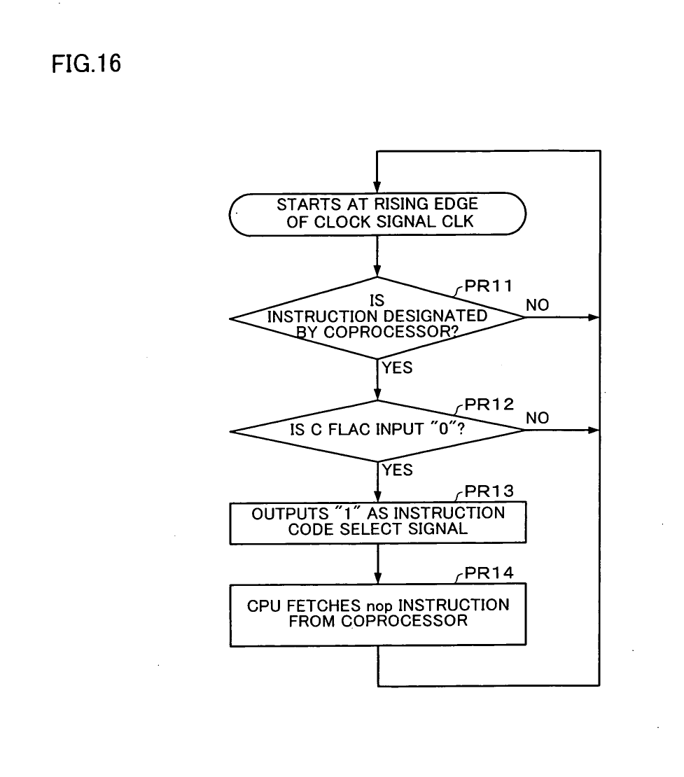

FIG. 16 is a flowchart showing the saturation processing. Processing PR11 to PR13 indicates processing performed by the coprocessor 30, and processing PR14 indicates processing performed by the CPU 10. For example, the control section 33-1 may perform the processing PR1 to PR3. After the saturation processing has been started in synchronization with the rising edge of the clock signal CLK, whether or not the instruction code IR1 input to the coprocessor 30 from the CPU 10 is an instruction code indicating processing performed by the calculation processing section 33 is determined in the processing PR11. For example, when the coprocessor code CCD of the instruction code IR1 is a code indicating processing performed by the calculation processing section 33, the processing PR12 in the subsequent stage is performed.

In the processing PR12, whether or not the C flag is “0” is determined. When the C flag has been determined to be “0”, the processing PR13 in the subsequent stage is performed.

In the processing PR13, the instruction code select signal CS12 is set at a logic “1”, for example. The instruction code select signal CS12 set at a logic “1” indicates a signal which causes the instruction code select circuit MUX_IRC to select the instruction code IR2.

In the processing PR14, the CPU 10 fetches the “nop” instruction as the instruction code IR2 supplied from the coprocessor 30.

This enables the coprocessor 30 to determine occurrence of an overflow and to perform the saturation processing based on the determination result at high speed.

3.4 Register Data of Coprocessor

3.4.1 Processing of Supplying Register Data to Register File

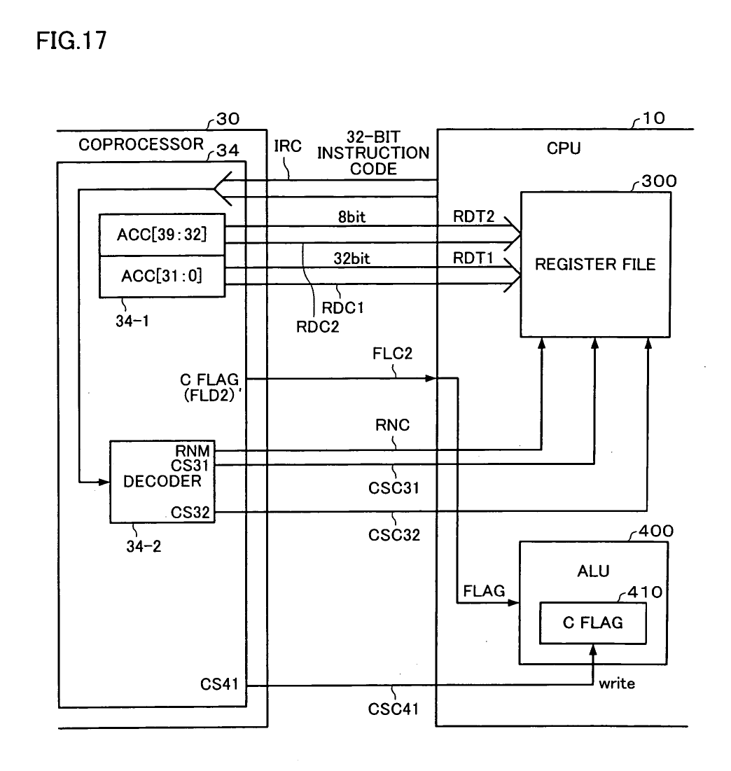

FIG. 17 is a block diagram when supplying the register data RDT1 and RDT2 of the coprocessor 30 to the CPU 10. The coprocessor 30 includes a calculation processing section 34. The calculation processing section 34 includes an accumulation register (ACC) 34-1 and a decoder 34-2. The accumulation register 34-1 may store 40 bits of data, for example. The instruction code IR1 is input to the calculation processing section 34 from the CPU 10 through the instruction code input line IRC. The calculation processing section 34 performs processing based on the instruction code IR1, and stores the processing result in the accumulation register 34-1, for example.

The lower-order 32-bit data (31st bit to 0th bit data) among the 40 bits of data stored in the accumulation register 34-1 is supplied to the register file 300 of the CPU 10 as the first register data RDT1 through the first register data supply line RDC1, for example. The higher-order 8-bit data (39th bit to 32nd bit data) among the 40 bits of data stored in the accumulation register 34-1 is supplied to the register file 300 of the CPU 10 as the second register data RDT2 through the second register data supply line RDC2, for example.

The decoder 34-2 supplies the register number RNM and the register select signals CS31 and CS32 to the register file 300 of the CPU 10 based on the instruction code IR1 input from the CPU 10. For example, the decoder 34-2 can supply the register data RDT1 of the accumulation register 34-1 to one arbitrary register among the registers R0 to R15 by generating the register number RNM based on the instruction code IR1.

A large amount of data can be supplied to the CPU 10 at high speed by using the calculation processing section 34 configured as described above.

The flag data FLD2 (e.g. C flag) generated in the processing performed by the calculation processing section 34 is supplied to the CPU 10 through the second flag data supply line FLC2. This allows the CPU 10 to use the value stored in the flag register 410 in the next instruction code. Therefore, the overflow processing or the like can be performed at high speed for the calculation result obtained by the coprocessor 30.

The calculation processing section 34 supplies to the CPU 10 the flag data write signal CS41 which controls whether or not to store the flag data FLD2 in the flag register 410 of the ALU 400. When storing the flag data FLD2 in the flag register 410, the flag data write signal CS41 is set to active. The flag register 410 stores the flag data FLD2 based on the activated flag data write signal CS41. This allows the coprocessor 30 to not store the flag data FLD2 in the flag register 410 when the flag data FLD2 (e.g. C flag) generated by the coprocessor 30 is unnecessary for the CPU 10.

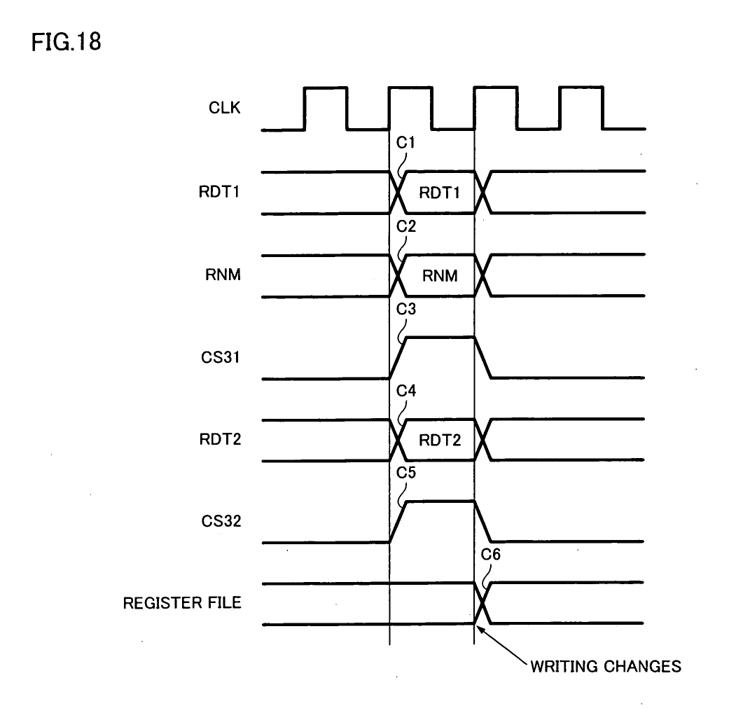

FIG. 18 is a timing chart of the processing shown in FIG. 17. In the calculation processing section 34, the calculation result obtained by the calculation processing section 34 is stored in the accumulation register 34-1. The lower-order 32-bit data of the calculation result is stored in the lower-order 32 bits of the accumulation register 34-1 as the register data RDT1 at a timing indicated by C1, for example. The register data RDT1 is supplied to the register file 300 of the CPU 10.

The decoder 34-2 generates the register number RNM based on the instruction code IR1 as indicated by C2, and supplies the register number RNM to the register file 300 of the CPU 10. The decoder 34-2 supplies the register select signal CS31 set to active as indicated by C3 to the register file based on the instruction code IR1.

The higher-order 8-bit data of the calculation result obtained by the calculation processing section 34 is stored in the higher-order eight bits of the accumulation register 34-1 as the register data RDT2 at a timing indicated by C4, for example. The register data RDT2 is supplied to the register file 300 of the CPU 10.

The decoder 34-2 supplies the register select signal CS32 set to active as indicated by C5 to the register file based on the instruction code IR1.

After the above-described processing has been performed, the register data RDT1 and RDT2 is stored in the register file 300 as indicated by C6 in synchronization with the next rising edge of the clock signal CLK, for example. Specifically, in one embodiment of the invention, the register data RDT1 and RDT2 and the flag data FLD2 can be supplied to the CPU 10 at one operating clock signal of the CPU 10, for example. Therefore, the CPU 10 can use the register data RDT1 and RDT2 and the flag data FLD2 when executing the next instruction code, so that processing such as the saturation processing can be performed at high speed, for example.

3.4.2 Processing of Supplying Register Data to Write Data Bus

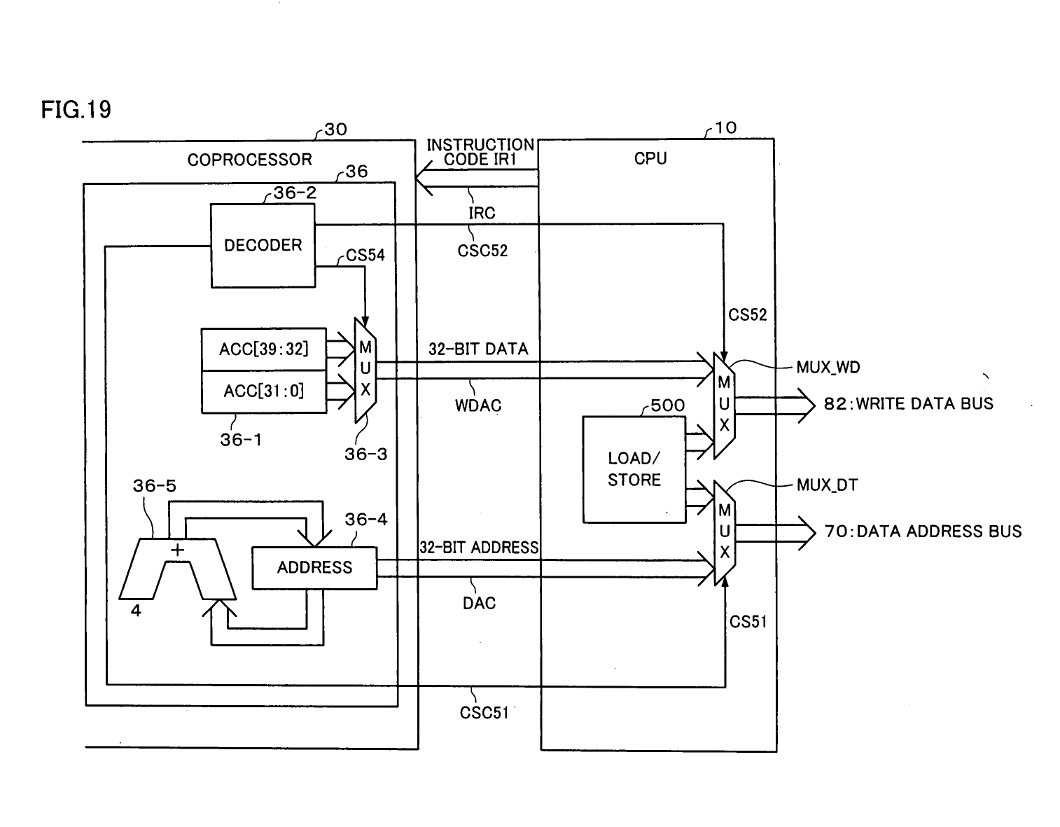

FIG. 19 is a block diagram when supplying the register data RDT1 and RDT2 of the coprocessor 30 to the write data bus 82. The coprocessor 30 includes a calculation processing section 36. The calculation processing section 36 includes an accumulation register (ACC) 36-1, a decoder 36-2, an accumulation register data select circuit 36-3, a data address output section 36-4, and an adder 36-5. The calculation processing section 36 may have a configuration in which some of these constituent elements are omitted. For example, the adder 36-5 may be a subtractor. The data address output section 36-4 may be formed by a register, for example.

The accumulation register 36-1 may store 40 bits of data, for example. The instruction code IR1 is input to the calculation processing section 36 from the CPU 10 through the instruction code input line IRC. The calculation processing section 36 performs processing based on the instruction code IR1, and stores the processing result in the accumulation register 36-1, for example.

The decoder 36-2 supplies the data address select signal CS5 1 and the write data select signal CS52 to the register file 300 of the CPU 10 based on the instruction code IR1 input from the CPU 10. The decoder 36-2 supplies an accumulation register data select signal CS54 to the accumulation register data select circuit 36-3 based on the instruction code IR1 input from the CPU 10, for example.

The lower-order 32-bit data (31st bit to 0th bit data) and the higher-order 8-bit data (39th bit to 32nd bit data) among the 40 bits of data stored in the accumulation register 36-1 are supplied to the accumulation register data select circuit 36-3, for example. The accumulation register data select circuit 36-3 selects either the lower-order 32-bit data or the higher-order 8-bit data based on the accumulation register data select signal CS54, and supplies the selected data to the CPU 10 as the write data WDA1 through the write data supply line WDAC.

The data address output section 364 supplies the data address DTAD to the CPU 10 through the data address supply line DAC. The data address output section 36-4 is formed by a register, for example. The output from the data address output section 36-4 is subjected to addition processing by the adder 36-5. The adder 36-5 adds a given value (e.g. “4”) to the value output from the data address output section 36-4, and outputs the addition result to the data address output section 36-4, for example.

The data address output section 36-4 stores the addition result obtained by the adder 36-5 in synchronization with the rising edge of the clock signal CLK, for example. Specifically, the data address DTAD which is sequentially incremented is supplied from the data address output section 36-4 to the data address select circuit MUX_DT of the CPU 10 in synchronization with the rising edge of the clock signal CLK, for example.

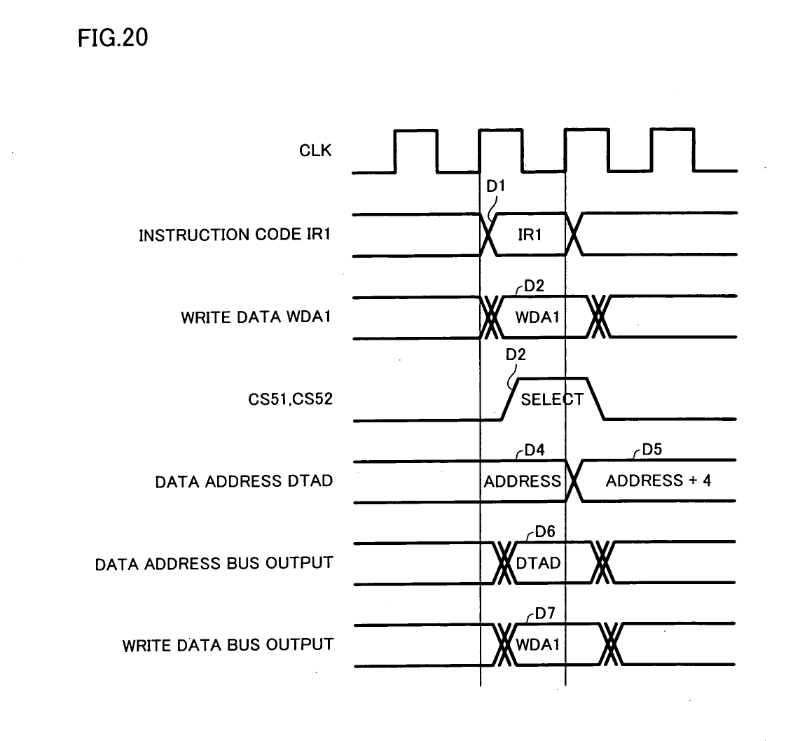

FIG. 20 is a timing chart of the processing shown in FIG. 19. The instruction code IR1 is supplied to the coprocessor 30 at a timing indicated by D1. In the calculation processing section 36, the calculation result obtained by the calculation processing section 36 is stored in the accumulation register 36-1. The lower-order 32-bit data or the higher-order 8-bit data of the calculation result is selected by the accumulation register data select circuit 36-3, and supplied to the CPU 10 as the write data WDA1 as indicated by D2, for example.

When supplying the write data WDA1 to the write data bus 82 from the coprocessor 30, the data address select signal CS51 and the write data select signal CS52 supplied from the decoder 36-2 are set to active (e.g. high level) as indicated by D3.

The data address DTAD is output from the data address output section 36-4 as indicated by D4, and the data address DTAD which is incremented by “4” is output at a timing indicated by D5, for example.

The data address select circuit MUX_DT of the CPU 10 supplies the data address DTAD to the data address bus 70 based on the data address select signal CS51, as indicated by D6. In this case, the data address DTAD supplied to the data address bus 70 is the data address DTAD indicated by D4.

The write data select circuit MUX_WD of the CPU 10 supplies the write data WDA1 to the write data bus 82 based on the write data select signal CS52, as indicated by D7.

As described above, the data address DTAD and the write data WDA1 can be respectively supplied to the data address bus 70 and the write data bus 82 at timings indicated by D6 and D7 after the instruction code IR1 has been input as indicated by D1. Specifically, the data address DTAD and the write data WDA1 generated by the coprocessor 30 can be respectively supplied to the data address bus 70 and the write data bus 82 at high speed.

For example, processing of storing the processing result of the coprocessor 30 each time a predetermined address of the memory 20 is incremented can be performed at high speed.

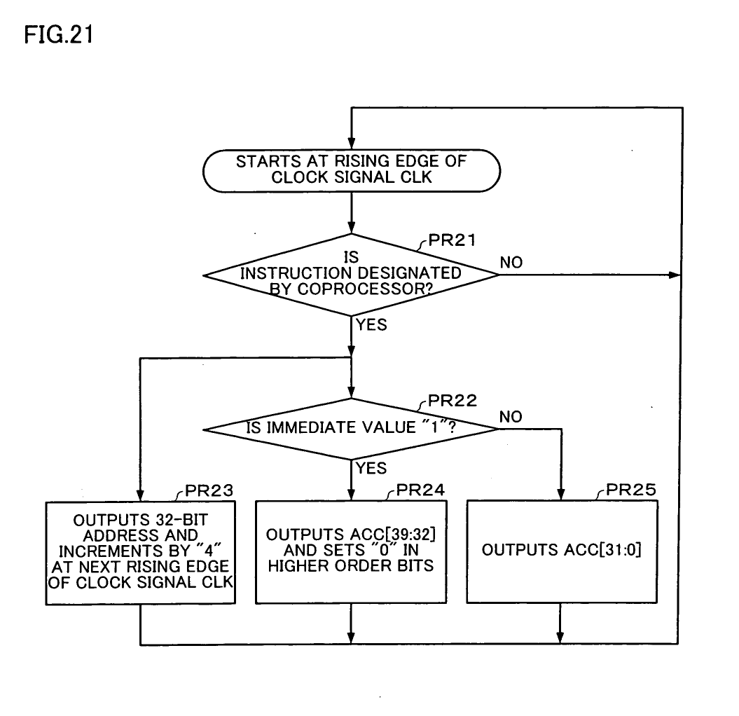

FIG. 21 is a flowchart relating to the processing shown in FIG. 20. Processing PR21 to PR25 indicates processing performed by the coprocessor 30. After the processing has been started in synchronization with the rising edge of the clock signal CLK, whether or not the instruction code IR1 input to the coprocessor 30 from the CPU 10 is an instruction code indicating processing performed by the calculation processing section 36 is determined in the processing PR21. For example, when the coprocessor code CCD of the instruction code IR1 is a code indicating processing performed by the calculation processing section 36, the processing PR22 and PR23 in the subsequent stage is performed.

In the processing PR22, whether or not the value of the immediate data imm12 included in the instruction code IR1 is “1” is determined. When the value of the immediate data imm12 is “1”, the processing PR24 in the subsequent stage is performed. When the value of the immediate data imm12 is not “1”, the processing PR25 in the subsequent stage is performed.

In the processing PR23, the data address DTAD is output from the data address output section 36-4. The data address DTAD is incremented by a given value (e.g. “4”) in synchronization with the next rising edge of the clock signal CLK, for example.

In the processing PR24, the calculation processing section 36 outputs the higher-order 8 bits of the data stored in the accumulation register 36-1 to the CPU 10, for example. When outputting the data, the calculation processing section 36 sets the higher-order 8 bits of the data stored in the accumulation register 36-1 in the higher-order eight bits of the 32-bit write data WDA1, for example. The calculation processing section 36 sets the remaining higher-order 24 bits of the write data WDA1 at “0”. The write data WDA1 set as described above is supplied to the CPU 10.

In the processing PR25, the calculation processing section 36 outputs the lower-order 32 bits of the data stored in the accumulation register 36-1 to the CPU 10 as the write data WDA1, for example.

In one embodiment of the invention, the higher-order eight bits or the lower-order 32 bits of the data stored in the accumulation register 36-1 can be selected and supplied to the CPU 10 by the processing PR22. The selection may be made based on the value set as the immediate data imm12, for example. For example, it may be defined that the higher-order eight bits of the data stored in the accumulation register 36-1 be used when a value “1” is set as the immediate data imm12. This enables a part of the data of the calculation processing section 36 to be selected based on the instruction code IR1 and supplied to the CPU 10 as the write data supplied to the write data bus 82.

### 4. COMPARISON WITH COMPARATIVE EXAMPLE

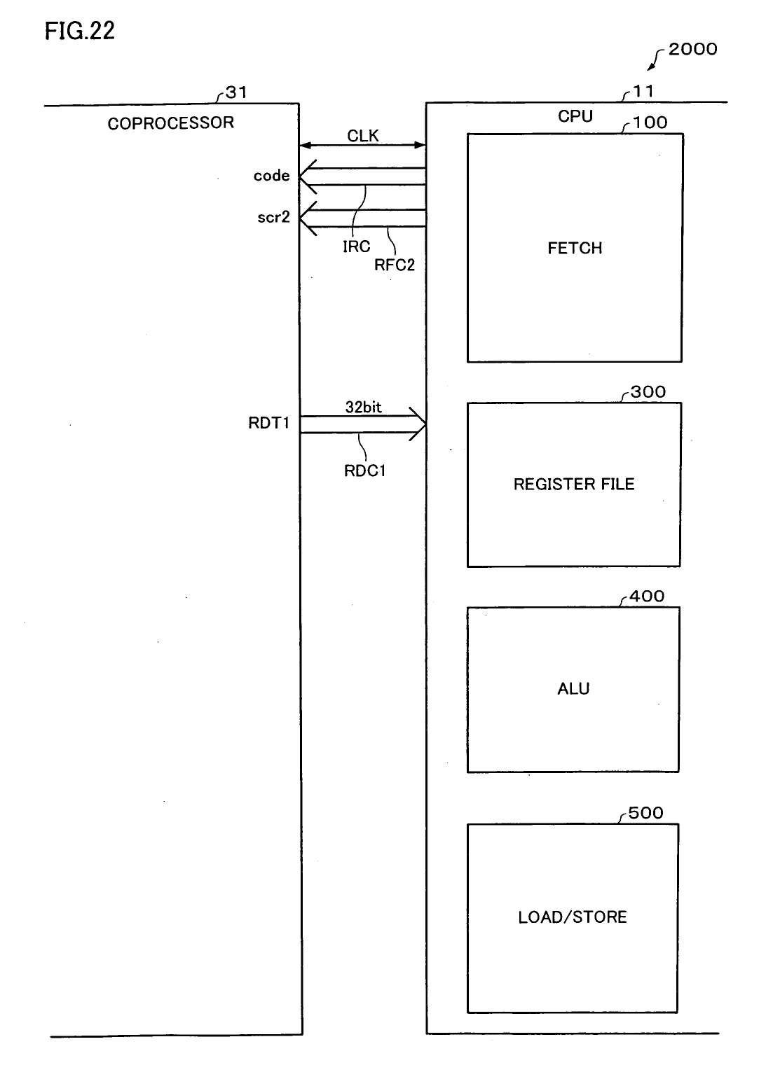

FIG. 22 is a diagram showing the connection relationship between a CPU 11 of an integrated circuit device 2000 which is a comparative example according to one embodiment of the invention and a coprocessor 31. In the comparative example, the 32-bit instruction code 22 (code) output from the fetch section 100 is supplied to the coprocessor 31 through the instruction code supply line IRC, for example. The register data src2 output from the output terminal RQ2 of the register file 300 is supplied to the coprocessor 31 through the second register file supply line RFC2. For example, a value stored in one of the registers R0 to R15 of the register file 300 may be supplied to the coprocessor 31. The coprocessor 31 supplies the 32-bit register data RDT1 to the CPU 11 through the coprocessor data input line RDC1, for example.

In the comparative example, when the coprocessor 31 supplies data to the CPU 11, the data must be supplied through the register file 300, for example. In this case, since it is necessary to at least store the data in the register file 300 and read the stored data, the processing speed is decreased. When the size of data generated by the coprocessor 31 is large or the number of types of data is two or more, it is necessary to supply the data to the register file 300 a number of times. This also decreases the processing speed.

When supplying data generated by the coprocessor 31 to the write data bus 82, the data must be supplied through the register file 300. When supplying a data address generated by the coprocessor 31 to the data address bus 70, the data address must be supplied through the register file 300. In these cases, since it is also necessary to process instructions a number of times, the processing speed is decreased.

In one embodiment of the invention, various types of data are supplied to the CPU 10 from the coprocessor 30 through the supply lines IRC, PCC, CIAC, CICC, CSC11, CSC12, RDC1, CSC31, RNC, RDC2, CSC32, FLC2, CSC41, DAC, CSC51, WDAC, CSC52, CSC53, RDAC, and the like, as described above. Therefore, according to one embodiment of the invention, data or the like can be supplied to the CPU 10 from the coprocessor 30 at one operating clock signal of the CPU 10. Specifically, one embodiment of the invention can reduce a decrease in the processing speed occurring in the comparative example. In one embodiment of the invention, it is unnecessary to additionally provide a logic circuit block having a complicated hardware configuration in comparison with the comparative example. Specifically, since only some select circuits are provided, an increase in the hardware scale can be minimized. Therefore, high-speed processing can be realized with a small circuit scale in comparison with the comparative example.

For example, when performing the loop processing shown in FIG. 9 in the comparative example, a number of types of processing such as determining occurrence of a branch and determining the end of the loop processing are frequently required. This decreases the processing speed of the CPU 11. Such a decrease in the processing speed becomes more significant along with an increase in the number of loops of the loop processing and an increase in the number of instruction codes executed in one loop processing. Specifically, in the comparative example, it is necessary to increase the frequency of the operating clock signal of the CPU 11 or additionally provide hardware which can execute a special instruction in order to perform the loop processing at high speed.

In one embodiment of the invention, the coprocessor 30 determines the end of the loop processing or the like, and can supply the determination result or the like to the CPU 10 without using the register file 300. Therefore, the processing time required in the comparative example can be significantly reduced, so that the loop processing can be performed at high speed in comparison with the comparative example.

When performing the saturation processing shown in FIG. 14 in the comparative example, it is necessary to determine the C flag and change the calculation result of the ALU 400 to a predetermined value based on the determination result. In the comparative example, it is also necessary to acquire the flag data from the flag register 410 and acquire the calculation result of the ALU 400. Therefore, since it is necessary to perform a number of types of processing, the processing speed is decreased.

In one embodiment of the invention, the coprocessor 30 can change the instruction code fetched by the fetch section 100 of the CPU 10 based on the flag data FLD1 of the CPU 10. Therefore, the integrated circuit device 1000 which can perform the saturation processing at high speed in comparison with the comparative example can be realized using a simple circuit configuration as shown in FIG. 14.

When supplying the register data with a large bit length as shown in FIG. 17 to the CPU in the comparative example, it is necessary to divide the data and separately supply the divided data to the register file 300. Therefore, processing time for a number of operating clock signals of the CPU 11 is required to supply the register data.

In one embodiment of the invention, since the register data supply line RDC2 is provided in addition to the register data supply line RDC1, the register data RDT1 and RDT2 can be supplied to the CPU 10 at one operating clock signal CLK of the CPU 10. Specifically, the calculation result of the coprocessor 30 or the like can be supplied to the CPU 10 at high speed in comparison with the comparative example. Moreover, the flag data FLD2 based on the calculation result of the coprocessor 30 can be supplied to the CPU 10 at the same time, so that the CPU 10 can immediately perform processing based on the flag data FLD2.

When supplying the write data from the coprocessor as shown in FIG. 19 to the write data bus in the comparative example, the write data must be supplied through the register file 300. Therefore, the write data from the coprocessor 31 is stored in the register file 300, and the stored write data is supplied to the write data bus 82. In this case, since the CPU 10 executes some instructions, the processing time is increased.

In one embodiment of the invention, since the write data supply line WDAC and the data address supply line DAC are provided, data can be supplied to the write data bus 82 and the data address bus 70 at one operating clock signal CLK of the CPU 10. Therefore, according to one embodiment of the invention, the write data can be supplied to the write data bus 82 at high speed in comparison with the comparative example. Moreover, since the write data select circuit MUX_WD and the data address select circuit MUX_DT are provided in the CPU 10, the write data and the data address can be switched based on the data address select signal CS51 and the write data select signal CS52 supplied from the coprocessor 30. Therefore, processing which takes time in the comparative example (e.g. processing shown in FIG. 19) can be performed at high speed in comparison with the comparative example.

The coprocessor 30 operates at a clock frequency the same as the clock frequency of the CPU 10. However, the coprocessor 30 may operate at a clock frequency differing from the clock frequency of the CPU 10.

### 5. MODIFICATION

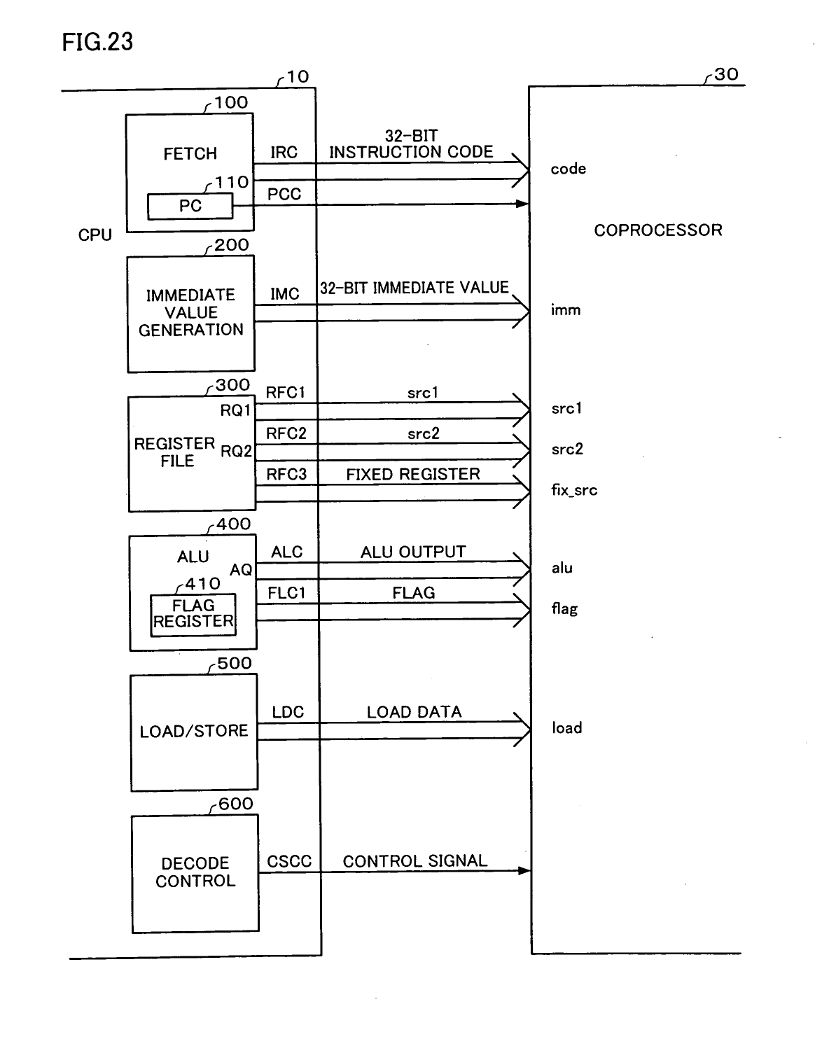

FIG. 23 shows a configuration of a modification according to one embodiment of the invention.

The integrated circuit device 1000 may further include an immediate data supply line IMC for supplying immediate data output from the immediate value generation section 200 to the coprocessor 30. The integrated circuit device 1000 may further include first and second register file supply lines RFC1 and RFC2 (first to nth register file supply lines in a broad sense) for supplying outputs from first and second register select circuits 310 and 320 (first to nth register select circuits in a broad sense) of the register file 300 to the coprocessor 30, and a fixed register data supply line RFC3 for supplying an output from the register set as a fixed register to the coprocessor 30. The integrated circuit device 1000 may further include an ALU output supply line ALC for supplying the calculation result of the ALU 400 to the coprocessor 30. The integrated circuit device 1000 may further include a load data supply line LDC for supplying data read from the memory 20 by the load/store section 500 to the coprocessor 30, and a control signal supply line CSC for supplying a control signal from the decode control section 600 to the coprocessor 30.

The configuration of the integrated circuit device 1000 is not limited to the above-described configuration. For example, the CPU 10 may have a configuration in which the immediate data supply line IMC, the first and second register file supply lines RFC1 and RFC2, and the fixed register data supply line RFC3 are omitted. The coprocessor 30 outputs the calculation result of the coprocessor to the CPU 10 through the coprocessor data input line RDC1. However, the invention is not limited thereto.

The immediate value generation section 200 may be connected with one end of the immediate data supply line IMC, for example. The immediate value generation section 200 may be connected with the coprocessor 30 through the immediate data supply line IMC. In this case, the immediate value generation section 200 may supply the generated immediate data (e.g. 32-bit immediate data) to the coprocessor 30 through the immediate data supply line IMC.

The output terminal RQ1 of the first register select circuit 310 may be connected with one end of the register file supply line RFC1, for example. The output terminal RQ1 of the first register select circuit 310 of the register file 300 may be connected with the coprocessor 30 through the first register file supply line RFC1. In this case, the register file 300 may supply the value output from the output terminal RQ1 of the first register select circuit 310 to the coprocessor 30.

The ALU output terminal AQ may be connected with one end of the ALU output supply line ALC, for example. The ALU 400 may be connected with the coprocessor 30 through the ALU output supply line ALC. In this case, the output (e.g. calculation result) from the ALU 400 may be supplied to the coprocessor 30.

The load data output terminal LDD of the load/store section 500 may be connected with one end of the load data supply line LDC, for example. The load/store section 500 may be connected with the coprocessor 30 through the load data supply line LDC. In this case, the output (e.g. data read from the memory) from the load/store section 500 may be supplied to the coprocessor 30.

In the modification according to one embodiment of the invention configured as described above, data or the like can be supplied to the coprocessor 30 at one operating clock signal of the CPU 10. Specifically, a decrease in the processing speed can be reduced in comparison with the comparative example. In the modification, since it is unnecessary to additionally provide a logic circuit block having a complicated hardware configuration differing from the comparative example, high-speed processing can be realized with a smaller circuit scale than that of the comparative example.

In the modification, the immediate data supply line IMC, and the first and second register file supply lines RFC1 and RFC2 are connected with the coprocessor 30. Therefore, the CPU 10 can supply the data “imm”, “src1”, and “src2” to the coprocessor 30 at one operation clock signal of the CPU 10. Therefore, complicated product-sum calculation processing can be performed at high speed in comparison with the comparative example.

In the modification, the ALU output supply line ALC and the flag data supply line FLC1 are connected with the coprocessor 30. Therefore, the CPU 10 can supply the data “alu” and the C flag data to the coprocessor 30 at one operating clock signal of the CPU 10. Moreover, the calculation result “alu” can be supplied to the coprocessor 30 immediately after the value of the calculation result “alu” of the ALU 400 has been determined. Therefore, saturation processing or the like can be performed at high speed in comparison with the comparative example.

In modification, the instruction code input line IRC and the load data supply line LDC are connected with the coprocessor 30. Therefore, the CPU 10 can supply the data “load” and “imm12” to the coprocessor 30 at one operating clock signal of the CPU 10. Therefore, complicated product-sum processing can be performed at high speed in comparison with the comparative example.

As described above, since the integrated circuit device 1000 according to one embodiment of the invention can supply necessary data to the coprocessor 30 at one clock signal without additionally providing a complicated logic circuit block differing from the comparative example, complicated processing can be performed at high speed in comparison with the comparative example.

The coprocessor 30 operates at the same clock frequency as the CPU 10. However, the coprocessor 30 may operate at a clock frequency differing from the clock frequency of the CPU 10.

Although only some embodiments of the invention have been described in detail above, those skilled in the art will readily appreciate that many modifications are possible in the embodiments without departing from the novel teachings and advantages of this invention. Accordingly, all such modifications are intended to be included within the scope of this invention. For example, any term cited with a different term having broader or the same meaning at least once in this specification or drawings can be replaced by the different term in any place in this specification and drawings.

What is claimed is:

1. An integrated circuit device having a CPU which executes given processing based on an instruction code, the integrated circuit device comprising:
an instruction code bus used to supply an instruction code to the CPU from a memory; and
an instruction code supply line used to supply an instruction code output from a coprocessor to the CPU,
the CPU including:
a fetch section which fetches an instruction code; and
an instruction code select circuit which receives an instruction code input through the instruction code bus and an instruction code supplied through the instruction code supply line, and supplies one of the instruction codes to the fetch section.

2. The integrated circuit device as defined in claim 1, further comprising:
an instruction code select signal supply line used to supply an instruction code select signal to the instruction code select circuit from the coprocessor,
wherein the instruction code select circuit supplies one of an instruction code input through the instruction code bus and an instruction code supplied through the instruction code supply line to the fetch section based on the instruction code select signal.

3. An integrated circuit device having a CPU which executes given processing based on an instruction code, the integrated circuit device comprising:
an instruction address bus used to supply an instruction address to a memory; and
an instruction address supply line used to supply an instruction address output from a coprocessor to the CPU,
the CPU including:
a fetch section which fetches an instruction code; and
an instruction address select circuit which receives an instruction address supplied through the instruction address supply line and an instruction address supplied from the fetch section, and supplies one of the instruction addresses to the instruction address bus.

4. The integrated circuit device as defined in claim 3, further comprising:
a program counter which outputs a count value for generating an instruction address; and
a count value supply line used to supply the count value to the coprocessor, wherein the count value output from the program counter is supplied to the coprocessor through the count value supply line; and
wherein the fetch section generates an instruction address based on the count value output from the program counter, and supplies the generated instruction address to the instruction address select circuit.

5. The integrated circuit device as defined in claim 3, further comprising:
an instruction address select signal supply line used to supply an instruction address select signal to the instruction address select circuit from the coprocessor;
wherein the instruction address select circuit supplies one of an instruction address supplied through the instruction address supply line and an instruction address supplied from the fetch section to the instruction address bus, based on the instruction address select signal.

6. The integrated circuit device as defined in claim 3, further comprising:
an instruction code bus used to supply an instruction code to the CPU from the memory; and
an instruction code supply line used to supply an instruction code output from the coprocessor to the CPU,
the CPU including:
an instruction code select circuit which receives an instruction code supplied through the instruction code supply line and an instruction code input through the instruction code bus, and supplies one of the instruction codes to the fetch section.

7. An integrated circuit device having a CPU which executes given processing based on an instruction code, the integrated circuit device comprising:
first and second register data supply lines used to respectively supply first and second register data output from a coprocessor to the CPU,
the CPU including:
a register file including a plurality of registers; and
a first register data select circuit which receives the first register data supplied through the first register data supply line and CPU internal data, and supplies one of the first register data and the CPU internal data to the register file, and
the second register data output from the coprocessor being supplied to the register file through the second register data supply line.

8. The integrated circuit device as defined in claim 7, further comprising:
a first register data select signal supply line used to supply a first register data select signal to the first register data select circuit from the coprocessor,
wherein the first register data select circuit supplies one of the first register data and the CPU internal data to the register file based on the first register data select signal.

9. The integrated circuit device as defined in claim 8, further comprising:
a register number supply line used to supply a coprocessor designation register number which indicates one of the registers of the register file designated by the coprocessor to the register file from the coprocessor,
wherein the first register data select signal is supplied to the register file;
wherein the register file includes a register number select circuit which receives the coprocessor designation register number supplied from the coprocessor and an internal designation register number designated inside the CPU, and selectively outputs one of the coprocessor designation register number and the internal designation register number based on the first register data select signal; and
wherein at least one of the registers is write-enabled based on the register number selectively output from the register number select circuit.

10. The integrated circuit device as defined in claim 7,
wherein the CPU includes a second register data select circuit which receives the second register data supplied through the second register data supply line as a first input and data supplied from the first register data select circuit as a second input, and supplies one of the first and second inputs to at least one of the registers.

11. The integrated circuit device as defined in claim 10, further comprising:
a second register data select signal supply line used to supply a second register data select signal to the second register data select circuit from the coprocessor;
wherein the second register data select circuit supplies one of the first and second inputs from the second register data select circuit to at least one of the registers based on the second register data select signal.

12. An integrated circuit device having a CPU which executes given processing based on an instruction code, the integrated circuit device comprising:
a data address supply line used to supply a data address output from a coprocessor to the CPU,
the CPU including:
a load/store section which writes data into a memory by supplying a data address to the memory through a data address bus and supplying write data through a write data bus; and
a data address select circuit which receives a data address supplied through the data address supply line and a data address output from the load/store section, and supplies one of the data addresses to the data address bus.

13. The integrated circuit device as defined in claim 12, further comprising:
a data address select signal supply line used to supply a data address select signal to the data address select circuit from the coprocessor;
wherein the data address select circuit supplies one of a data address supplied through the data address supply line and an instruction address output from the load/store section to the data address bus, based on the data address select signal.

14. An integrated circuit device having a CPU which executes given processing based on an instruction code, the integrated circuit device comprising:
a write data supply line used to supply write data output from a coprocessor to the CPU,
the CPU including:
a load/store section which writes data into a memory by supplying a data address to the memory through a data address bus and supplying write data through a write data bus; and
a write data select circuit which receives write data supplied through the write data supply line and write data output from the load/store section, and supplies one of the write data to the write data bus.

15. The integrated circuit device as defined in claim 14, further comprising:
a write data select signal supply line used to supply a write data select signal to the write data select circuit from the coprocessor,
wherein the write data select circuit supplies one of write data supplied through the write data supply line and write data output from the load/store section to the write data bus based on the write data select signal.

16. An integrated circuit device having a CPU which executes given processing based on an instruction code, the integrated circuit device comprising:
a read data supply line used to supply read data output from a coprocessor to the CPU,
the CPU including:
a load/store section which reads data from a memory by supplying a data address to the memory through a data address bus and receiving read data through a read data bus; and
a read data select circuit which receives read data supplied through the read data supply line and read data supplied from the read data bus, and supplies one of the read data to the load/store section.

17. The integrated circuit device as defined in claim 16, further comprising:
a read data select signal supply line used to supply a read data select signal to the read data select circuit from the coprocessor,
wherein the read data select circuit supplies one of read data output from the coprocessor and read data output from the CPU to the load/store section, based on the read data select signal.

18. The integrated circuit device as defined in claim 1,
wherein the CPU includes:
an ALU which performs calculation processing based on an instruction code;
a first flag data supply line used to supply first flag data to the coprocessor, based on calculation result of the ALU; and
a second flag data supply line used to supply second flag data to the ALU, based on calculation result of the coprocessor; and
wherein the ALU includes:
a flag register which stores the first or second flag data; and
a flag data select circuit which receives the first and second flag data through the first and second flag data supply lines, and supplies one of the first and second flag data to the flag register.

19. The integrated circuit device as defined in claim 18,
wherein the CPU includes a flag data select signal supply line used to supply a flag data select signal to the ALU from the coprocessor; and
wherein the flag data select circuit of the ALU selectively outputs one of the first and second flag data to the flag register, based on the flag data select signal supplied through the flag data select signal supply line.
